(19) United States
(12) Patent Application Publication
(10) Pub. No.: US 2013/0131261 A1
(43) Pub. Date: May 23, 2013

(54) Process for Preparing Vinyl Acetate-Ethylene Copolymers by Means of Emulsion Polymerization

(71) Applicants: Helmut Zecha, Burghausen (DE); Gerhard Kögler, Burgkirchen (DE)

(72) Inventors: Helmut Zecha, Burghausen (DE); Gerhard Kögler, Burgkirchen (DE)

(73) Assignee: Wacker Chemie AG, Munich (DE)

(21) Appl. No.: 13/813,863

(22) PCT Filed: Jul. 25, 2011
(86) PCT No.: PCT/EP2011/062705

§ 371 Date: Feb. 1, 2013

(30) Foreign Application Priority Data
Aug. 2, 2010 (DE) 10 2010 038 788.6

(51) Int. Cl. C08F 2/06

(52) U.S. Cl. CPC C08F 2/06
USPC 524/563; 526/331

(57) ABSTRACT

The invention provides processes for preparing vinyl acetate-ethylene copolymers by means of free-radical initiated emulsion polymerization of vinyl acetate, ethylene and optionally one or more further comonomers in the presence of at least one protective colloid and optionally at least one emulsifier, characterized in that the vinyl acetate-ethylene copolymers contain 18 to 45% by weight of ethylene units, based on the total weight of the vinyl acetate-ethylene copolymers, and at least 70% by weight of ethylene units, based on the total weight of the ethylene units and of the further comonomer units of the vinyl acetate-ethylene copolymers, and the free-radical initiated emulsion polymerization is performed in the presence of A) 0.5 to 20% by weight, based on the total weight of the monomers used overall, of one or more solvents, or B) 0.1 to 20% by weight, based on the total weight of monomers used overall, of one or more solvents, and 0.5 to 4% by weight, based on the total weight of monomers used overall, of one or more anionic sulphosuccinic esters of the general formula R¹O—CO—CH₂—CH (SO₃M)—CO—O—R¹ (I) in which M is a cation, R¹ is a linear or branched alkyl radical having 4 to 17 carbon atoms, an alkylene oxide group —(R²—O)ₙ-X or a cation M, where R² is a linear or branched alkylene unit having 2 to 5 carbon atoms, n is an integer from 2 to 20 and X is a linear or branched alkyl radical having 4 to 17 carbon atoms, where at most one R¹ radical in the general formula (I) is a cation M.

### CROSS REFERENCE TO RELATED APPLICATIONS

This application is the national phase filing of international patent application No. PCT/EP2011/062705, filed 25 Jul. 2011, and claims priority of German application number 10 2010 038 788.6, filed 2 Aug. 2010, the entireties of which applications are incorporated herein by reference.

### FIELD OF THE INVENTION

The invention relates to processes for preparing vinyl acetate-ethylene copolymers by means of emulsion polymerization, to the vinyl acetate-ethylene copolymers obtainable accordingly, and to their use in adhesives, more particularly for the bonding of polymer substrates to cellulosic materials.

### BACKGROUND OF THE INVENTION

Processes of the emulsion polymerization of vinyl acetate with ethylene, optionally with further comonomers, in aqueous phase for the purpose of preparing polymer dispersions are long established. To achieve colloidal stability in the dispersions prepared accordingly, water-soluble polymers, such as polyvinyl alcohols, cellulose derivatives, or polyvinylpyrrolidones, for example, are used during the emulsion polymerization as what are called protective colloids and/or low molecular mass, interface-active substances, referred to as emulsifiers or surfactants.

DE-A 1595402, for instance, describes processes in which the rate of incorporation of ethylene into vinyl acetate-ethylene copolymers is improved by the initial introduction of at least 75% of the vinyl acetate monomer and the conduct of the polymerization in the presence of emulsifiers. DE-A 2112769 recommends, for the purpose of ensuring a uniform course of polymerization, the use, in the copolymerization of vinyl esters with ethylene, of a redox initiator system with the initial introduction in its entirety of the reductant with the vinyl ester fraction, the ethylene, and the dispersants, and the metered addition only of the oxidant component. Polymerization takes place in the presence of polyvinyl alcohol and/or emulsifiers. U.S. Pat. No. 3,644,262 describes processes featuring an improved rate of incorporation of ethylene into vinyl acetate-ethylene polymers, in which the vinyl acetate fraction and the emulsifier and/or protective-colloid fraction are metered in their entirety or are introduced initially only in very small fractions. This process allows up to about 20% of ethylene to be incorporated into the copolymer at low pressures and temperatures.

The aqueous polymer dispersions obtainable accordingly and based on vinyl acetate and ethylene (VAE dispersions) are used for example as binders, more particularly for adhesives, for paints, or for the binding of fibers or nonwovens.

Over the years, however, the requirements imposed on the profile of properties of such VAE dispersions have become continually more specific. Adhesives, for example, face increasingly more exacting requirements in relation to the bonding of materials with low surface energy, such as is the case, for example, for the bonding of polymeric films to cellulosic materials, such as paper or cardboard. Common VAE dispersions, such as the products of DE-A 1595402 or U.S. Pat. No. 3,644,262, for example, are unsuitable for such purposes, since they do not result in sufficient adhesion of the bonded assembly. Consequently, a variety of attempts have been undertaken with the aim of providing VAE dispersions featuring improved adhesion.

U.S. Pat. No. 3,708,388 describes adhesives based on vinyl acetate-ethylene copolymers that are stabilized with alkylphenol ethoxylate emulsifiers and, optionally, protective colloids, and which have a defined intrinsic viscosity and can be used for laminating films. In the course of the preparation at least 75% of the vinyl acetate is introduced initially. To improve the mechanical strength at high temperatures, the use of crosslinkers is recommended.

EP 1212383 A1 describes processes for producing adhesives featuring improved adhesion by preparation of aqueous polymer dispersions by emulsion polymerization and the addition of emulsifiers after the end of the polymerization. EP 1212383 A1 teaches that adhesion is improved only on subsequent addition of the emulsifiers, whereas the use of emulsifiers during the polymerization does not lead to any improvement in the adhesion. Disadvantageously, with products in accordance with EP 1212383 A1, it is not possible to access adhesives having a level of properties with high cohesion and high adhesion; accordingly, for example, the adhesion to polyester films is too low and the setting rate of the dispersions is too low.

EP 890625 A1 describes vinyl acetate-ethylene polymer dispersions which meet defined values for a storage modulus of the polymer, and which are recommended as an adhesive for surfaces that are difficult to bond, such as polyethylene, polyester, metalized polyester, and oriented polypropylene. The use of chain transfer agents is recommended for the preparation of the polymer dispersions, and, in the polymerization procedure, less than 15% of vinyl acetate is included in the initial reactor charge, and also the vinyl acetate content during the polymerization is kept lower than 5%. Polymer dispersions obtainable accordingly possess a high level of adhesion to polymer films that are difficult to bond. A disadvantageous feature is the inadequate cohesion of the film of adhesive. Moreover, alkylphenol ethoxylates having 4 to 100 ethylene oxide units are used as nonionic emulsifiers. Such emulsifiers, however, are deprecated on account of their detrimental effect on health and the environment.

EP 385734 A1 recommends particular vinyl acetate-ethylene polymers for adhesives with high setting rates. To prepare the vinyl acetate-ethylene copolymers, mixtures are used of partially hydrolyzed polyvinyl alcohols and nonionic polyoxyethylene emulsifiers with a defined HLB. A characteristic of the polymerization process is that 40% to 90% by weight of the vinyl acetate is emulsified into an aqueous solution comprising the entire amounts of polyvinyl alcohols, emulsifiers, and reductants, thus forming a stable emulsion, and the remaining 10% to 60% by weight of the vinyl acetate is metered in following injection of ethylene. Disadvantageously, this procedure as well does not give copolymers having a level of properties with high cohesion and high adhesion; the adhesion to polyester films is too low.

In U.S. Pat. No. 5,571,860 the proposal is made to improve the setting rate, the heat resistance, and the adhesion of adhesives based on vinyl acetate-ethylene copolymers by copolymerizing N-vinylformamide or N-vinylpyrrolidone. The heat resistance is also improved through use of 0.5% to 10% by weight of crosslinkable monomer, such as glycidyl methacrylate. In the preparation of the copolymers, 70% of the vinyl acetate used, together with 90% of the dispersants used, are included in the initial charge to the reactor, and the remainder is metered in. Dispersants employed are polyvinyl alcohols, optionally in a mixture with nonionic alkylphenol ethoxylate emulsifier. A disadvantage is that the copolymerization of N-vinylformamide or N-vinylpyrrolidone necessitates high polymerization temperatures and hence relatively high pressures, and the incorporation of ethylene is made more difficult. A further disadvantage is the use of alkylphenol ethoxylates as emulsifiers.

EP 279384 A1 describes vinyl acetate-ethylene polymer dispersions which are suitable for use as packaging adhesives, and teaches how a combination of low molecular mass polyvinyl alcohols and nonionic emulsifiers for stabilizing the dispersion additionally improves the setting rate of the adhesive even with a high solids content. In the polymerization, at least some of the low molecular mass polyvinyl alcohol, and all of the emulsifier fraction, are included in the initial charge. Products obtainable accordingly, however, produce inadequate adhesion between cellulosic materials and polyester films.

GB-A 1546275 describes vinyl acetate-ethylene polymer dispersions which when used as pressure-sensitive adhesives exhibit a good balance in terms of tack, cohesion, and adhesion. As shown by the inventive examples, which use exclusively hydroxyethylcellulose as protective colloid and nonionic emulsifier, and by the comparative examples, effective adhesion is achieved only through use of chain transfer agents and a protective-colloid fraction of not more than 1% by weight, based on total monomer. GB-A 1546275, furthermore, requires intrinsic viscosities of between 0.6 and 1.0 dl/g. The products obtained accordingly do possess good adhesion properties, but disadvantages are an inadequate cohesion and inadequate setting rate.

U.S. Pat. No. 4,267,090 concerns itself with adhesives which enhance the wettability of polyvinyl chloride substrates and the setting rate in conjunction with a high level of cohesion. For these purposes, U.S. Pat. No. 4,267,090 recommends vinyl acetate-ethylene polymer dispersions which are obtained by using defined amounts of preferably nonionic emulsifiers. However, the polymers obtainable accordingly are unable to provide satisfaction in terms of a level of properties featuring high cohesion and high adhesion, since the adhesion values for polyester films are too low.

U.S. Pat. No. 3,769,151 is concerned with the provision of adhesives based on vinyl acetate-ethylene copolymer dispersions featuring improved adhesive properties, particularly in relation to vinyl polymers, with simultaneous improvement in a thickening response. It describes a complicated procedure of seed emulsion polymerization of vinyl acetate, 5% to 20% by weight of ethylene in the copolymer and 0.01% to 1% by weight of unsaturated acids, using a mixture of partially hydrolyzed and fully hydrolyzed polyvinyl alcohols, with only partially hydrolyzed polyvinyl alcohol being used to prepare the seed, and with a blend with more highly hydrolyzed polyvinyl alcohol being used in the seed polymerization. Nonionic, cationic, or anionic emulsifiers are not accorded any influence over the adhesion and cohesive properties of the vinyl acetate-ethylene copolymer dispersions. In examples, the emulsion polymerization is carried out in the presence of polyvinyl alcohol and anionic emulsifier Aerosol MA, a diester of sulfosuccinic acid having 6 C atoms in the alkyl radical, or in the presence of nonionic nonylphenol ethoxylate, or of nonionic ethylene oxide-propylene oxide block copolymer or of unsaturated nonionic ethoxylated emulsifier. For the purpose of evaluating the adhesives properties, U.S. Pat. No. 3,769,151 describes a hot vinyl adhesion test for determining a creep resistance, which essentially characterizes the cohesion. Aqueous polymers according to U.S. Pat. No. 3,769,151 do possess a high level of cohesion, but the adhesion to polymer substrates, especially to polyesters, is too low, and so a level of properties with high cohesion and high adhesion is not achieved.

DE-A 102009001097 describes protective colloid- and emulsifier-stabilized dispersions of vinyl acetate-ethylene polymers and the use thereof in adhesives, the emulsifiers being nonionic emulsifiers optionally in combination with small amounts of anionic emulsifiers.

DE-A 102009001097 discloses ethylene-vinyl acetate copolymers which are prepared by means of emulsion polymerization in the presence of protective colloids and selected nonionic emulsifiers and which when used as or in adhesives exhibit what is referred to as an equal-weighted adhesion-cohesion balance on the part of the ethylene-vinyl acetate copolymers.

The prior art therefore provides vinyl acetate-ethylene copolymers which when used in adhesives exhibit either a high level of cohesion of the adhesive film or a high level of adhesion of the adhesive film to polymer substrates, but do not allow a level of properties with high cohesion and high adhesion to be achieved. Typically, these vinyl acetate-ethylene copolymers are stabilized in the presence of protective colloids—polyvinyl alcohol is usually used. As far as the amount of protective colloid used is concerned, GB-A 1546275 teaches that fractions of more than 1% by weight, based on monomer, deleteriously affect the adhesion. Emulsifiers are often used for additional stabilization of the polymer particles. Here it is frequently nonionic emulsifiers, more particularly alkylphenol ethoxylates, that are employed, whereas according to GB-A 1546275 the use of anionic emulsifiers is disadvantageous. According to EP 1212383 A1 and U.S. Pat. No. 3,769,151, the use of emulsifiers during the emulsion polymerization has no influence on the adhesives properties of the products. From EP 1212383 A1, however, it is known that the subsequent addition of emulsifiers to a polyvinyl alcohol-stabilized dispersion can improve the adhesion.

It was an object of the present invention, therefore, to provide aqueous dispersions of vinyl acetate-ethylene copolymers, and processes for preparing them, with which the aforementioned disadvantages of known aqueous dispersions of vinyl acetate-ethylene copolymers, in terms of inadequate adhesion on the part of the adhesive film produced therefrom, relative to substrates that are difficult to bond, such as polymer substrates, and more particularly to polyester films or polystyrene films, are overcome and at the same time the disadvantages of known polymers in respect of insufficient cohesion are eliminated, and, overall, a level of properties with high cohesion and high adhesion is achieved.

This adhesion refers to the adhesion between a substrate and an adhesive film produced from an aqueous dispersion of a vinyl acetate-ethylene copolymer. Cohesion is that within the adhesive film produced from an aqueous dispersion of a vinyl acetate-ethylene copolymer.

The minimum requirements in terms of a level of properties with high cohesion and high adhesion in an adhesive can be quantified by the following parameters, whereby the adhesive preferably produces an adhesive film having a cohesion, measured as thermal stability, of at least 0.2 N/mm², preferably of at least 0.4 N/mm², and preferably at the same time meets the following adhesion parameters:

(i) Adh PS is preferably at least 3.8 N/cm, where Adh PS stands for the peel strength possessed by an adhesively bonded assembly of cotton with Sidaplax® Polyflex 90 polystyrene (PS film) at a peel rate of 5 mm/min;

(ii) Adh PET1 is preferably at least 3.4 N/cm, where Adh

PET1 stands for the peel strength of an adhesively bonded assembly of cotton and Hostaphan® RN125 polyethylene terephthalate film (PET film) at a peel rate of 10 mm/min; and

(iii) Adh PET2 is preferably at least 1.2 N/cm, where Adh PET2 stands for the peel strength of an adhesively bonded assembly of cotton and Hostaphan® RN125 polyethylene terephthalate film (PET film) at a peel rate of 900 mm/min.

A further component of the minimum requirements with regard to a level of properties with high cohesion and high adhesion is that the adhesive should fulfill a cumulative adhesion, CA, of CA preferably ≦18, more particularly of CA≦17.

Furthermore, adhesive films of aqueous dispersions of the vinyl acetate-ethylene copolymers ought to have a high setting rate—that is, in particular, they ought to be characterized by a tack speed (TS) of preferably 3.0 seconds or less.

The individual methods, conditions, and materials for determining the aforementioned parameters in relation to cohesion, adhesion, cumulative adhesion, and tack speed are described later on below in detail under the heading “Test methods for determining the adhesives properties”.

Lastly, the aqueous dispersions of vinyl acetate-ethylene copolymers ought to possess good machine travel properties and to enable easy cleaning of machine parts, such as applicator rolls. Where possible, during the preparation of the vinyl acetate-ethylene copolymers, it ought to be possible to do without the use of chain transfer agents, more particularly of aldehyde compounds and mercapto compounds; seed latex, the use of alkylphenol ethoxylates (APEOs); or vinyl chloride monomer as comonomer.

Surprisingly, the objects have been achieved in particular through the synergistic interaction of the ethylene content of the vinyl acetate-ethylene copolymers and the use of solvents, more particularly alkyl alcohols, and also, optionally, defined amounts of specific anionic sulfosuccinic esters during the emulsion polymerization for preparing the vinyl acetate-ethylene copolymers.

The addition of solvents to emulsion polymers for the purpose of enhancing performance properties is known. Thus, for example, GB81625, GB682773, and GB895153 describe the addition of methanol, ethanol, ethylene glycol, glycerol, acetone, or methyl acetate as antifreezing agent when implementing polymerizations below 0° C., for example.

In GB1018448 it is said that by adding methanol, ethanol, or isopropanol it is possible to coagulate crosslinkable acrylate dispersions post-synthesis in order to separate off the polymers; the same is said in GB548356 and in GB601807 as well. GB 928209 and GB1116509 use alcohols, such as methanol or ethanol, for purifying polymers. GB621467 describes the emulsion polymerization of conjugated diene compounds, such as butadiene, optionally with styrene or chlorinated styrene in an aqueous alcoholic medium. GB573366 mentions the usefulness of water/ethanol mixtures as a medium for the emulsion polymerization of vinyl chloride in order to increase the solubility of VC in the aqueous phase. U.S. Pat. No. 4,708,139 describes the emulsion polymerization of cationic latices (acrylates/amino group-modified acrylates) in water/alcohol mixtures for improving the colloidal stability and reducing particle aggregation processes, and for improving the mechanical stability of the dispersions. Solvents mentioned include alcohols, glycols, esters, cyclic ethers, and hydroxylated ethers. DE1123470 describes the use of specific cationic surfactants and solvents, such as methanol or hexylene glycol, in the emulsion polymerization of vinyl esters. RO116556 describes vinyl acetate/acrylate emulsion polymerizations in the presence of anionic and nonionic emulsifiers and also coalescants from the ethanol or acetone group. JP11209430 describes the emulsion polymerization of (meth)acrylates in the presence of cyclic organic phosphates in water/alcohol mixtures. U.S. Pat. No. 3,577,376 describes the emulsion polymerization of vinyl acetate and acrylamide using alkyl alcohols, especially methanol, but also ethanol, isopropanol, and tert-butanol, and also further solvents such as formamide, dimethylformamide, dimethylacetamide, and dimethyl sulfoxide, as solubilizing agents for the dissolution of acrylamide in vinyl acetate. DE2512589 describes self-crosslinking vinyl acetate-ethylene copolymers consisting of ethylene, vinyl acetate, a copolymerizable N-methylol compound, (meth)acrylic ester(s), an unsaturated carboxylic acid, and polyunsaturated monomers. Dispersants may be emulsifiers and optionally protective colloids. In example 8 of DE2512589, a polymerization is conducted in the absence of protective colloid in the presence of methanol. Methanol here is able to counteract the formation of coarsely particulate fractions (sieve residue). DE1770395 relates to binders for pigments and fillers for paints and also as additional binders for mortars, and describes the preparation of terpolymers by means of emulsion polymerization of vinyl chloride, vinyl esters, and ethylene in the presence of protective colloids, nonionic emulsifiers, and solvating agents, such as plasticizers or solvents. The weight ratio of vinyl chloride to ethylene is 1:2 to 3:1.

The use of solvents in emulsion polymerization, as known to date, has pursued a wide variety of objectives, with solvents in particular acting for example as antifreezing agents, for improving the colloidal stability and avoiding particle aggregation events, such as the formation of sieve residue, or for improving the shear stability. Vinyl acetate (co)polymers obtained in the presence of solvents, as described in DE1123470, DE2512589, and DE1770395, are not suitable, however, as adhesives for the bonding, for example, of cellulosic materials, such as paper or cardboard, to polymer substrates, more particularly to polystyrene and polyester films, since they do not bring about sufficient adhesion and/or do not bring about sufficient cohesion.

### SUMMARY OF THE INVENTION

The invention provides processes for preparing vinyl acetate-ethylene copolymers by means of radically initiated emulsion polymerization of vinyl acetate, ethylene, and optionally one or more further comonomers in the presence of at least one protective colloid and optionally at least one emulsifier, characterized in that the vinyl acetate-ethylene copolymers contain 18% to 45% by weight of ethylene units, based on the total weight of the vinyl acetate-ethylene copolymers, and

at least 70% by weight of ethylene units, based on the total weight of the ethylene units and of the further comonomer units of the vinyl acetate-ethylene copolymers, and

the radically initiated emulsion polymerization is carried out in the presence of

A) 0.5% to 20% by weight, based on the total weight of the entirety of monomers used, of one or more solvents, or

B) 0.1% to 20% by weight, based on the total weight of the entirety of monomers used, of one or more solvents and 0.5% to 4% by weight, based on the total weight of the entirety of monomers used, of one or more anionic sulfosuccinic esters of the general formula

R¹—O—CO—CH₂—CH(SO₃M)—CO—O—R¹ (I)

in which

M is a cation,

R¹ is a linear or branched alkyl radical having 4 to 17 C atoms, an alkylene oxide group —(R²—O)ₙ—X, or a cation M, where

R² is a linear or branched alkylene unit having 2 to 5 C atoms,

n is an integral value from 2 to 20, and

X is a linear or branched alkyl radical having 4 to 17 C atoms,

where not more than one radical R¹ in the general formula (I) is a cation M.

The invention further provides vinyl acetate-ethylene copolymers obtainable by means of radically initiated emulsion polymerization of vinyl acetate, ethylene, and optionally one or more further comonomers in the presence of at least one protective colloid and optionally at least one emulsifier, characterized in that

the vinyl acetate-ethylene copolymers contain 18% to 45% by weight of ethylene units, based on the total weight of the vinyl acetate-ethylene copolymers, and

at least 70% by weight of ethylene units, based on the total weight of the ethylene units and of the further comonomer units of the vinyl acetate-ethylene copolymers, and

the vinyl acetate-ethylene copolymers are obtainable by radically initiated emulsion polymerization in the presence of

A) 0.5% to 20% by weight, based on the total weight of the entirety of monomers used, of one or more solvents, or

B) 0.1% to 20% by weight, based on the total weight of the entirety of monomers used, of one or more solvents and 0.5% to 4% by weight, based on the total weight of the entirety of monomers used, of one or more anionic sulfosuccinic esters of the general formula

R¹—O—CO—CH₂—CH(SO₃M)-CO—O—R¹ (I)

in which

M is a cation,

R¹ is a linear or branched alkyl radical having 4 to 17 C atoms, an alkylene oxide group —(R²—O)ₙ—X, or a cation M, where

R² is a linear or branched alkylene unit having 2 to 5 C atoms,

n is an integral value from 2 to 20, and

X is a linear or branched alkyl radical having 4 to 17 C atoms,

where not more than one radical R¹ in the general formula (I) is a cation M.

The individual radicals X, R¹, and R², and also M and the parameter n in the general formula (I) may adopt their meaning in each case independently of one another. The abbreviation C atom stands for a carbon atom. The anionic sulfosuccinic esters of the general formula (I) are a specific embodiment of anionic emulsifiers. The term “monomers” stands for ethylenically unsaturated compounds and encompasses vinyl acetate, ethylene, and also the auxiliary monomers and further comonomers that are present optionally.

### DETAILED DESCRIPTION OF THE INVENTION

In the text below, those embodiments of the present invention in which one or more anionic sulfosuccinic esters of the general formula I are necessary employed are referred to as alternative B). The other embodiments, which do not require any use of the aforementioned sulfosuccinic esters, are referred to below as alternative A).

Ethylene and ethylene units have the empirical chemical formula C₂H₄. The fraction of ethylene units in the vinyl acetate-ethylene copolymers is preferably 19% to 40% by weight, more preferably 20% to 35% by weight, and most preferably 22% to 32% by weight, based in each case on the total weight of the vinyl acetate-ethylene copolymers.

The fraction of vinyl acetate units in the vinyl acetate-ethylene copolymers is generally 60% to 81% by weight, preferably 65% to 80% by weight, more preferably 68% to 78% by weight, and most preferably 68% to 76% by weight, based in each case on the total weight of the vinyl acetate-ethylene copolymers.

Besides vinyl acetate and ethylene it is possible optionally to use further comonomers in the emulsion polymerization. Examples of further comonomers are vinyl esters of carboxylic acids having 3 to 18 C atoms. Preferred vinyl esters are vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 C atoms, as for example VeoVa9® or VeoVa10® (trade names of the company Hexion). Other suitable further comonomers are those from the group of the esters of acrylic acid or methacrylic acid with unbranched or branched alcohols having 1 to 15 C atoms. Preferred methacrylic esters or acrylic esters are esters such as methyl acrylate, methyl methacrylate, ethyl acrylate, ethyl methacrylate, propyl acrylate, propyl methacrylate, n-butyl acrylate, n-butyl methacrylate, 2-ethylhexyl acrylate, and norbornyl acrylate. Other suitable comonomers are vinyl halides such as vinyl chloride, or vinylaromatics, such as styrene, or olefins such as propylene.

The further comonomers are used preferably at 1% to 19% by weight and more preferably t 2% to 15% by weight, and most preferably 2% to 10% by weight, based in each case on the total amount of vinyl acetate and ethylene.

Optionally it is possible additionally in the emulsion polymerization to use 0.05% to 10% by weight, preferably 0.05% to 5% by weight, based on the total amount of vinyl acetate and ethylene, of auxiliary monomers. Examples of auxiliary monomers are ethylenically unsaturated monocarboxylic and dicarboxylic acids, preferably acrylic acid, methacrylic acid, fumaric acid, and maleic acid; ethylenically unsaturated carboximides and carbonitriles, preferably acrylamide and acrylonitrile; monoesters and diesters of fumaric acid and maleic acid such as the diethyl and diisopropyl esters, and also maleic anhydride, ethylenically unsaturated sulfonic acids and their salts, preferably vinylsulfonic acid and 2-acryloamido-2-methylpropanesulfonic acid. Further examples are precrosslinking comonomers such as polyethylenically unsaturated comonomers, examples being divinyl adipate, diallyl maleate, allyl methacrylate, or triallyl cyanurate, or postcrosslinking comonomers, examples being acrylamidoglycolic acid (AGA), methylacrylamidoglycolic acid methyl ester (MAGME), N-methylolacrylamide (NMA), N-methylolmethacrylamide (NMMA), N-methylolallylcarbamate, alkyl ethers such as the isobutoxy ether or esters of N-methylolacrylamide, of N-methylolmethacrylamide, and of N-methylolallylcarbamate. Also suitable are epoxide-functional comonomers such as glycidyl methacrylate and glycidyl acrylate. Other examples are silicon-functional comonomers, such as acryloyloxypropyltri(alkoxy)- and methacryloyloxypropyltri(alkoxy)-silanes, vinyltrialkoxysilanes, and vinylmethyldialkoxysilanes, where alkoxy groups present may be, for example, methoxy, ethoxy, and ethoxypropylene glycol ether radicals. Mention may also be made of monomers having hydroxyl or CO groups, examples being hydroxyalkyl esters of methacrylic acid and acrylic acid such as hydroxyethyl, hydroxypropyl, or hydroxybutyl acrylate or methacrylate, and also compounds such as diacetoneacrylamide and acetylacetoxyethyl acrylate or methacrylate.

It is preferred not to copolymerize N-vinylformamide and/or N-vinylpyrrolidone. It is also preferred not to copolymerize acrylonitrile and/or vinyl halide, such as vinyl chloride.

The fraction of the ethylene units in the vinyl acetate-ethylene copolymers is preferably at least 80% by weight, more preferably at least 90% by weight, and most preferably at least 95% by weight, based on the total weight of the ethylene units, of the further comonomer units, and, optionally, of the auxiliary monomer units in the vinyl acetate-ethylene copolymers.

Most preference is given to vinyl acetate-ethylene copolymers which contain no units of further comonomers and/or no units of auxiliary monomers.

The polymerization takes place according to the emulsion polymerization process in the aqueous medium, the polymerization temperature being generally 40° C. to 100° C., preferably 50° C. to 90° C., and especially 60° C. to 80° C. The polymerization pressure is generally between 40 and 100 bar, preferably between 45 and 90 bar, and most preferably between 45 and 85 bar.

The polymerization is preferably initiated using the redox initiator combinations customary for emulsion polymerization.

Examples of suitable oxidation initiators are the sodium, potassium, and ammonium salts of peroxo-disulfuric acid, hydrogen peroxide, tert-butyl peroxide, tert-butyl hydroperoxide, potassium peroxodiphosphate, tert-butyl peroxopivalate, cumene hydroperoxide, isopropylbenzene monohydroperoxide, and azobisisobutyronitrile. Preference is given to the sodium, potassium, and ammonium salts of peroxodisulfuric acid, and hydrogen peroxide. The stated initiators are used generally in an amount of 0.05% to 2.0% by weight, based on the total weight of the monomers.

Suitable reducing agents are the sulfites and bisulfites of the alkali metals and of ammonium, as for example sodium sulfite, the derivatives of sulfoxylic acid such as zinc or alkali metal formaldehyde-sulfoxylates, as for example sodium formaldehyde-sulfoxylate (Brüggolit®), and also formaldehyde-free derivatives of sulfinic acid, and mixtures thereof, known under the trade name Brüggolit® FF6, and (iso)ascorbic acid, and also tartaric acid. Preference is given to Brüggolit®, Brüggolit® FF6, (iso)ascorbic acid and salts thereof, such as Na isoascorbate, for example, and tartaric acid. The amount of reducing agent is preferably 0.05% to 3% by weight, based on the total weight of the monomers.

Among preferred initiators are the redox initiator combination of hydrogen peroxide and Brüggolit® or Brüggolit® FF6. Hydrogen peroxide is used here generally in an amount of 0.06% to 0.4% by weight, preferably from 0.1% to 0.3% by weight, more preferably 0.15% to 0.25% by weight, based on total monomer. The ratio of oxidizing agent to reducing agent is in that case generally from 10:70 to 10:3, preferably 10:60 to 10:6, and very preferably from 10:60 to 10:10 weight fractions. More particularly it may be advantageous to set the molar ratio of reducing agent (Red) to oxidizing agent (Ox) at Red/Ox values≦1.0, preferably to Red/Ox values≦0.8, and with particular preference to Red/Ox values≦0.5.

Preferred protective colloids are partially hydrolyzed or fully hydrolyzed polyvinyl alcohols, referred to as standard polyvinyl alcohols, having an average degree of hydrolysis of 85 to 99.9 mol %. Preferred on the one hand are partially hydrolyzed standard polyvinyl alcohols or mixtures of such polyvinyl alcohols having an average degree of hydrolysis of 86 to 96 mol %. Particularly preferred are partially hydrolyzed polyvinyl alcohols having an average degree of hydrolysis of 86 to 90 mol %, preferably in each case having a mass-average degree of polymerization of 600 to 2000. For adjusting the viscosity of the resultant polymer dispersion it may be advantageous to use mixtures of polyvinyl alcohols having different degrees of polymerization, in which case the degrees of polymerization of the individual components may be smaller or greater than the mass-average degree of polymerization of 600 to 2000 for the mixture.

On the other hand it is also preferred to use fully hydrolyzed standard polyvinyl alcohols having an average degree of hydrolysis of 96.1 to 99.9 mol %, preferably having an average degree of hydrolysis of 97.5 to 99.5 mol %, alone or in mixtures with partially hydrolyzed standard polyvinyl alcohols, with the fully hydrolyzed polyvinyl alcohols being characterized preferably by a mass-average degree of polymerization of 600 to 3500.

As well as such standard polyvinyl alcohols, however, it is also possible to use modified polyvinyl alcohols, such as, for example, those which carry functional groups, such as acetoacetyl groups, for example, or those which contain comonomer units, such as vinyl laurate-modified or Versatic acid vinyl ester-modified polyvinyl alcohols, for example, or—and preferably—ethylene-modified polyvinyl alcohols, which are known, for example, under the trade name EXCEVAL®, alone or in combination with the stated standard polyvinyl alcohols. Preferred ethylene-modified polyvinyl alcohols have an ethylene fraction of up to 12 mol %, preferably 1 to 7 mol %, and more preferably 2 to 6 mol %; more particularly 2 to 4 mol %. The mass-average degree of polymerization is in each case from 500 to 5000, preferably 2000 to 4500, more preferably 3000 to 4000. The average degree of hydrolysis is generally greater than 92 mol %, preferably 94.5 to 99.9 mol %, and more preferably 98.1 to 99.5 mol %. It is of course also possible, and may be advantageous, to use mixtures of different ethylene-modified polyvinyl alcohols alone or in combination with partially hydrolyzed and/or fully hydrolyzed standard polyvinyl alcohols.

Other suitable protective colloids are water-soluble cellulose derivatives, for example and preferably hydroxyethylcellulose, having viscosities in 2% strength by weight aqueous solutions of ≦6500 mPas, preferably of ≦3500 mPas, more preferably of ≦1500 mPas, and more particularly of ≦500 mPas.

Suitable protective colloids are, furthermore, polyvinylpyrrolidones having K values of between 10 and 30.

It may also be advantageous to use mixtures of the stated polyvinyl alcohols with water-soluble cellulose derivatives and/or polyvinylpyrrolidones, or mixtures of water-soluble cellulose derivatives and polyvinylpyrrolidones. Water-soluble means that the solubility thereof in water under standard conditions is >1 g/100 ml water.

The protective colloids are generally present during the polymerization in an amount of in total 1% to 7% by weight, preferably 1.5% to 5.5% by weight, more preferably 2% to 4% by weight, and more particularly 2% to 3.5% by weight, based in each case on the total weight of the monomers.

The protective colloids, especially the polyvinyl alcohols, may be present in the form of ingredients which in addition to one or more protective colloids include a fraction of one or more solvents, especially alkyl alcohols such as methanol. The ingredients preferably include a solvent fraction of 0.1% to 3% by weight, preferably 0.1% to 2.6% by weight, more preferably 0.1% to 2.0% by weight, and most preferably 0.1% to 1% by weight, based in each case on the total mass of the ingredient. The protective colloids, especially the polyvinyl alcohols, are used generally in the form of ingredients which contain up to a maximum of 5% by weight of volatile organic substances and residual moisture, such as water, based on the total mass of the ingredients. The other constituents that are present as well as protective colloids in these ingredients are frequently present as impurities in commercially available protective colloids.

A key aspect of the present invention is the performance of the emulsion polymerization in the presence of one or more solvents. The solvents generally produce a solution with water and/or vinyl acetate. A solution is a single-phase, homogeneous mixture of at least two different substances, and under standard conditions in accordance with DIN50014 is in the form of a liquid. The solubility of the solvent under standard conditions in accordance with DIN50014 is preferably more than 2 g, particularly more than 10 g, in 100 g of water and/or in 100 g of vinyl acetate.

Examples of suitable solvents are linear or cyclic glycol ethers, especially diethylene glycol or dipropylene glycol, diols, more particularly ethylene glycol or 1,2-propanediol, triols, more particularly glycerol, or, generally, alkyl alcohols, especially alkyl alcohols having 1 to 5 C atoms. Preferred solvents are alkyl alcohols having 1 to 5 C atoms, more preferably 2 to 4 C atoms, and most preferably 2 to 3 C atoms. Examples of suitable alkyl alcohols are methanol, ethanol, or propanol. Ethanol or 2-propanol are preferred. In the process of the invention it is preferred not to add any methanol as solvent. Methanol is deprecated in many applications because of its toxic properties. This does not mean, however, that the substances (reactants) used in the aforementioned preferred embodiment of the process of the invention, examples being ingredients comprising protective colloids such as polyvinyl alcohols, may not nevertheless include fractions of methanol. In one particularly preferred embodiment, however, all of the reactants, more particularly ingredients, are free from methanol.

In the case of alternative A) of the present invention, the solvents are present during the emulsion polymerization at 0.5% to 10% by weight, preferably 0.7% to 8% by weight, more preferably 0.9% to 7% by weight, and most preferably at 1% to 6% by weight, based in each case on the total weight of the monomers, it being possible to combine the aforementioned values arbitrarily.

In the case of alternative B) of the present invention, the solvents are present during the emulsion polymerization at 0.2% to 10% by weight, preferably 0.3% to 5% by weight, more preferably 0.3% to 4.2% by weight, more preferably 0.4% to 4.1% by weight, very preferably 0.6% to 4.1% by weight, and most preferably 0.8% to 4.0% by weight, based in each case on the total weight of the monomers, it being possible to combine the aforementioned values arbitrarily.

For both alternatives the aforementioned amounts of solvents also include the fractions of solvents which are introduced into the process of the invention as an impurity or as an entrainment with the reactants, as for example the ingredients, such as any alkyl alcohol impurities in polyvinyl alcohol.

In the case of alternative B) to the present invention, the use of one or more anionic sulfosuccinic esters of the general formula (I) is a further key aspect.

M is preferably a cation of hydrogen or of the alkali/alkaline earth metals, or an ammonium ion, more preferably a cation of the alkali/alkaline earth metals or an ammonium ion, and most preferably a cation of sodium or potassium or of ammonium.

Preferred linear or branched alkyl radicals R¹ in the general formula (I) contain at least 4 C atoms, more preferably at least 6 C atoms, even more preferably at least 7 C atoms, very preferably at least 8 C atoms, even more preferably at least 9 C atoms, and most preferably at least 10 C atoms up to preferably not more than 14 C atoms and more preferably not more than 13 C atoms. In the aforementioned embodiments of R¹, the aforementioned values for the number of the C atoms in the linear or branched alkyl groups may occur in any desired combinations.

Preferred alkylene oxide groups —(R²—O)ₙ—X contain as R² preferably a linear or branched alkylene unit having 2 to 3 C atoms and more preferably an alkylene unit having 2 C atoms. In the preferred alkylene oxide groups —(R²—O)ₙ—X, n is preferably an integral value from 2 to 20, more preferably from 2 to 10, and most preferably from 3 to 6. Preferred alkylene oxide groups —(R²—O)ₙ—X contain as X preferably, more preferably, even more preferably, and most preferably the same linear or branched alkyl radicals which are listed accordingly for R¹ in the general formula (I).

Preference is given to diesters of the anionic sulfosuccinic esters of the general formula (I); in other words, preferably all of the R¹ radicals in the general formula (I) are linear or branched alkyl radicals having 4 to 17 C atoms or are alkylene oxide groups —(R²—O)ₙ—X; in other words, there is preferably no R¹ in the general formula (I) that represents a cation M.

Examples of suitable anionic sulfosuccinic esters of the general formula (I) are dioctyl sulfosuccinate sodium salts or diethylhexyl sulfosuccinate sodium salts, also known under the trade names Aerosol® OT or Empimin® OT; or didecyl sulfosuccinate sodium salts, also known under the trade names Geropon® DDS65 or Empimin® ID65; or diisotridecyl sulfosuccinate sodium salts, also known under the trade names Geropon® Bis/Sodico or Empimin® TR70 or Aerosol® TR70; or monoesters of the sulfosuccinic esters of the general formula (I) in which R¹ is —(R²—O)ₙ—X and R² is an alkylene unit having 2 C atoms, X is a linear or branched alkyl radical having 10 to 12 C atoms, and n is an integral value from 3 to 6, and M may take on the definitions indicated above, also known, in the form of the sodium salts, under the trade names Geropon® ACR4 or Aerosol® A102 or Empicol® PCA507 or Empicol® SDD; or diesters of the sulfosuccinic esters of the general formula (I) in which R¹ is —(R²—O)ₙ—X and R² is an alkylene unit having 2 C atoms, X is a linear or branched alkyl radical having 6 to 14 C atoms, and n is an integral value from 2 to 10, and M may adopt the definitions indicated above.

The anionic sulfosuccinic esters of the general formula (I) may be used in the form of a pure substance, as a mixture with vinyl acetate and/or other comonomers, as a mixture with water, or as a mixture with one or more solvents and optionally water, in the process according to the invention.

It is also possible to use mixtures of two or more anionic sulfosuccinic esters of the general formula (I). Also possible is the use of one or more anionic sulfosuccinic esters of the general formula (I) in a mixture with one or more nonionic emulsifiers and/or one or more other anionic emulsifiers.

Examples of suitable nonionic emulsifiers which can be used in a mixture with the anionic sulfosuccinic esters of the general formula (I) are nonionic, ethoxylated emulsifiers having a branched or linear alkyl radical, polyalkylene oxides, or block copolymers of alkylene oxides. Preference is given to ethoxylated fatty alcohols, including oxo-process alcohols, with a branched or straight-chain alkyl radical, where the alkyl radical has 4 to 40 C atoms, preferably 8 to 18 C atoms, and is ethoxylated with 2 to 60, preferably 4 to 40, ethylene oxide units. Examples of such are C12 to C14 fatty alcohols having 3 to 40 ethylene oxide units, C13 to C15 fatty alcohols (oxo-process alcohols) having 3 to 40 ethylene oxide units, C16 to C18 fatty alcohols having 11 to 60 ethylene oxide units, C10 or C13 fatty alcohols (oxo-process alcohols) having 3 to 40 ethylene oxide units, polyoxyethylenesorbitan monooleate having 20 ethylene oxide units. Particularly preferred ethoxylated fatty alcohols here are the polyethylene oxide ethers with 2 to 60 ethylene oxide units of linear alcohols (such as oleyl alcohol, stearyl alcohol) or isotridecyl alcohol. Also preferred as nonionic, ethoxylated emulsifiers are copolymers of ethylene oxide (EO) and propylene oxide (PO) with an ethylene oxide fraction of 10% to 40% by weight and a molar mass of 1500 to 3000. Particularly preferred are EO-PO copolymers with an EO fraction of 10% to 30% by weight. Advantageously it is also possible to use mixtures of the stated emulsifiers.

Examples of suitable anionic emulsifiers, which can be used in a mixture with the anionic sulfosuccinic esters of the general formula (I), are linear or branched alkyl sulfates having 2 to 20, 6 to 16, especially 8 to 14 C atoms, or ethoxylated anionic emulsifiers, especially linear or branched alkyl ether sulfates having 4 to 40 C atoms and 2 to 40 ethylene oxide units.

Preferred embodiments use one or more of the anionic sulfosuccinic esters of the general formula (I) in a mixture with one or more nonionic ethoxylated emulsifiers with a linear or branched alkyl radical or in a mixture with one or more nonionic ethylene oxide and propylene oxide copolymers.

In alternative B) the anionic sulfosuccinic esters of the general formula (I) are present in general in an amount of in total 0.5% to 4% by weight, preferably 0.8% to 3.5% by weight, more preferably 1.0% to 3.0% by weight, and most preferably 1.2% to 2.7% by weight, based in each case on the total weight of the monomers, during the emulsion polymerization.

In alternative B) the fraction of the anionic emulsifiers, preferably of the anionic sulfosuccinic esters of the general formula (I), is generally at least 10% by weight, preferably at least 30% by weight, more preferably at least 50% by weight, even more preferably at least 51% by weight, more preferably at least 55% by weight, very preferably at least 60%, and with even more particular preference at least 80% by weight, very preferably at least 90% by weight, and especially from 90% to 99% by weight, based in each case on the total weight of the entirety of emulsifiers used in emulsion polymerization. In alternative B) most preferably the anionic sulfosuccinic esters of the general formula (I) are used exclusively as emulsifiers in the emulsion polymerization.

In alternative B) the anionic sulfosuccinic esters of the general formula (I) are present in general in an amount of 11.1% to 80.0% by weight, preferably 18.6% to 6.7% by weight, more preferably 20.5% to 55.6% by weight, and most preferably 37.5% to 53.5% by weight, based in each case on the total weight of the protective colloids and anionic sulfosuccinic esters of the general formula (I), during the emulsion polymerization.

The anionic sulfosuccinic esters of the general formula (I) are present in alternative B) generally in an amount of 10.0% to 79.4% by weight, preferably 16.6% to 61.2% by weight, more preferably 20.5% to 54.2% by weight, and most preferably 24.0% to 51.4% by weight, based in each case on the total weight of the emulsifiers and protective colloids, during the emulsion polymerization.

The emulsifiers in alternative B) are present generally in an amount of 11.2% to 88.7% by weight, preferably 18.8% to 75.8% by weight, more preferably 25.7% to 70.2% by weight, and most preferably 27.6% to 68.6% by weight, based in each case on the total weight of the emulsifiers and protective colloids, during the emulsion polymerization.

In alternative A) as well it is possible to use one or more nonionic or ionic emulsifiers alone or in a mixture. Examples of those suitable for this purpose are the aforementioned nonionic or ionic emulsifiers. Ionic emulsifiers are preferably anionic emulsifiers. Examples of suitable anionic emulsifiers are listed earlier on above in the description of the emulsifiers for alternative B). For alternative A), sulfosuccinic esters of the general formula (I) are generally excluded from emulsifiers, especially ionic emulsifiers.

In the case of alternative A) it is possible for emulsifiers, used optionally, to be present in an amount of 0.1% to 4% by weight, preferably 0.5% to 3.5% by weight, and more preferably 1.0% to 3.0% by weight, based in each case on the total weight of the monomers, during the emulsion polymerization. Preferred embodiments of alternative A) use no emulsifiers.

In alternative A) and in alternative B), emulsifiers used are preferably not alkylphenol ethoxylates. Alkylphenol ethoxylates are detrimental to health and to the environment.

The solvents may be introduced in the form of mixtures with the monomers, protective colloids and/or, optionally, emulsifiers, more particularly with the anionic sulfosuccinic esters of the general formula (I). Thus it is possible to supply mixtures of one or more solvents with one or more protective colloids or with premixes comprising one or more protective colloids and one or more solvents to the process of the invention. It is also possible for one or more solvents to be mixed with one or more anionic sulfosuccinic esters of the general formula (I) or with premixes comprising one or more anionic sulfosuccinic esters of the general formula (I) and one or more solvents, and supplied in the form of the resultant mixtures to the process of the invention. In the process of the invention these mixtures may be used as initial charge or metered feed. For preparing the mixtures, the emulsifiers and/or protective colloids or the aforementioned premixes and/or ingredients are admixed with preferably 0.0% to 3.8% by weight, more preferably 0.5% to 3.8% by weight, and most preferably 0.5% to 3.0% by weight, of solvents, based on the total weight of the monomers.

Some or all of the solvents may be included in the initial reactor charge before the emulsion polymerization is initiated, or may be metered in wholly or partly during the emulsion polymerization. In substantial fractions, for example, the solvents may be metered in during the emulsion polymerization. When emulsifiers are used, the solvents are preferably distributed in the same proportion as the emulsifiers between initial charge and metered feed. It is particularly preferred in this case for a relatively large fraction of the solvents to be metered in and included in the initial charge simultaneously, but optionally in spatial separation, with a portion of the anionic sulfosuccinic esters of the general formula (I) after the emulsion polymerization has been initiated.

Vinyl acetate is preferably included in the initial reactor charge, before the emulsion polymerization is initiated, at 10% to 70% by weight, more preferably at 10% to 50% by weight, very preferably at 15% to 50% by weight, and most preferably at 22% to 42% by weight, based in each case on the total weight of the entirety of vinyl acetate used.

Before the emulsion polymerization is initiated it is preferred to include 40% to 100% by weight, more preferably 50% to 100% by weight, and most preferably 50% to 75% by weight of ethylene in the initial reactor charge, based in each case on the total weight of the entirety of ethylene used.

Where further comonomers or auxiliary monomers are used as well as vinyl acetate and ethylene, they may be included in their entirety in the initial reactor charge before initiation takes place, or they may be metered in their entirety during the reaction. The further comonomers or auxiliary monomers as well may be included partially in the initial charge and partially in metered feeds.

It is preferred to include at least 20% by weight, more preferably at least 50% by weight, and most preferably 100% by weight of the protective colloids in the initial charge before the emulsion polymerization is initiated, based in each case on the total weight of the entirety of protective colloids used. Alternatively the protective colloids may be metered at 100%, based on the total weight of the entirety of protective colloids used.

When emulsifiers are being used they are preferably included at not less than 25% by weight, more preferably not less than 40% by weight, very preferably at 55% to 85% by weight, and most preferably at 62% to 82% by weight in the initial charge before the emulsion polymerization is initiated, based in each case on the total weight of the entirety of emulsifiers used. Alternatively the emulsifiers can be metered at 100%, based on the total weight of the entirety of emulsifiers used.

The solvents are preferably included to an extent of not less than 20% by weight, more preferably not less than 30% by weight, more preferably not less than 40% by weight, and even more preferably not less than 50% by weight, most preferably not less than 65% by weight, and especially at 80% to 100% by weight in the initial charge before the emulsion polymerization is initiated, based in each case on the total weight of the entirety of solvents used. Any remaining fraction of solvent in this case is metered in. Alternatively the solvents may be metered in to an extent of at least 50% by weight, preferably at least 65% by weight, more preferably at least 85% by weight, and most preferably at 90 to 100% by weight, based in each case on the total weight of the entirety of solvents used, after the emulsion polymerization has been initiated. Any remaining fraction of solvent in this case is included in the initial charge.

More particularly, solvents, especially alkyl alcohols, are included in the initial charge to an extent of at least 50% by weight, preferably at least 65% by weight, more preferably at least 85% by weight, and most preferably at 90% to 100% by weight, based in each case on the total weight of the entirety of solvents used, before the emulsion polymerization is initiated, provided they are used in a fraction of 0.5% to 4% by weight, based on the entirety of monomers used.

Also more particularly, solvents, especially alkyl alcohols, are metered in to an extent of at least 50% by weight, preferably at least 65% by weight, more preferably at least 85% by weight, and most preferably at 90% to 100% by weight, based in each case on the total weight of the entirety of solvents used, after the emulsion polymerization has been initiated, during the course of the emulsion polymerization, provided they are used in a fraction of greater than 4.5% by weight, based on the entirety of monomers used.

Surprisingly it is possible to control or increase in a tailored way the cohesion properties and/or adhesion properties of the vinyl acetate-ethylene copolymers thus obtainable, using not only the amount but also the distribution of the solvents between initial charge and metered feed.

The initiator is preferably metered in its entirety. Where a redox initiator combination is being used, it is preferred to include preferably one of the two components at least partly in the initial charge, and more preferably the reducing agent component is included at least partially in the initial charge.

The emulsion polymerization of the invention breaks down generally overall into the following phases or process steps:

(i) preparation of the initial reactor charge (ii) initiation of the polymerization, (iii) metering phase, (iv) full polymerization, (v) post polymerization, and optionally but preferably (vi) steam stripping and (vii) final adjustment. After, during or before the post polymerization, the polymerization batch is let down from the reactor into a downstream vessel, optionally accompanied by addition of defoaming agents. The batch is cooled during or after the post polymerization or after steam stripping. Final adjustment of solids content and/or viscosity, and addition of biocides, takes place typically on the batch cooled at least to 40° C.

When the emulsion polymerization is carried out, the procedure is generally such that the stated constituents of the reaction mixture, especially monomers, protective colloid, solvent and/or optionally emulsifier, are introduced initially in the stated proportions, and the initial charge is subsequently heated to polymerization temperature. On a larger scale, advantageously, the initial reactor charge is heated, before initiation is commenced, to a temperature which lies between 10° C. and 40° C. below the desired polymerization temperature, and the exothermic heat of reaction is utilized for heating the reactor to reaction temperature. After the polymerization temperature has been reached, the initiator or, in the case of a redox initiator combination, oxidizing agent and reducing agent are metered in and hence the start of reaction is triggered, and the uniform metered addition of the remaining amounts of monomer, optionally emulsifier, and optionally protective colloid is commenced following exothermic onset of the polymerization. In the metering phase it is also possible for the various metered feeds to be added with continuously or graduatedly rising or falling rates, in each case independently of one another, to the polymerization mixture of the initial charge during the course of the reaction. It is also possible for one or more metered feeds to be added each with a constant rate and for remaining metered feeds to be added with continuously or graduatedly rising or falling rates. The process operates preferably with rising rates for the monomer feeds, particularly for the metered addition of vinyl acetate, and for the initiator feed(s).

The pH during the polymerization reaction is about 2 to 7, preferably about 3 to 6, and more preferably about 3.5 to 5.5. For this it may be necessary to adjust the pH of the initial reactor charge before the commencement of initiation to pH levels of less than 6, preferably less than 5, and more preferably in the range between 3 and 4.5. Suitable substances for the pH adjustment include known organic or inorganic acids, among which phosphoric acid and formic acid are particularly preferred. It is also possible for customary buffer substances to be supplied to the initial reactor charge prior to initiation or to be metered in during the reaction; with preference it is possible to do without such buffer substances.

Volatile organic compounds (VOCs), such as residual monomers or solvents, may if desired be removed from the aqueous dispersions of the vinyl acetate-ethylene copolymers by distillation, for example, more particularly using entrainers (stripping), such as nitrogen or, preferably, steam. The latter is also known under the heading “steam stripping”. Distillation or stripping takes place preferably at temperatures from 50 to 100° C., preferably under reduced pressure. Stripping may also be repeated a number of times. Volatile organic compounds have a boiling point of less than 250° C. at atmospheric pressure.

The aqueous dispersions of the vinyl acetate-ethylene copolymers optionally have a volatile organic compounds content of preferably <2000 ppm and more preferably <1000 ppm, based on the weight of the aqueous dispersions; more particularly, the fraction of alkyl alcohols optionally is preferably ≦500 ppm, more preferably ≦100 ppm, and most preferably ≦75 ppm, based on the weight of the aqueous dispersions of the vinyl acetate-ethylene copolymers.

In one preferred embodiment the procedure is for 22% to 32% by weight of ethylene, based on total vinyl acetate and ethylene monomer; 1.5% to 3.5% by weight, based on the total weight of all the monomers, of protective colloids, more particularly of partially hydrolyzed standard polyvinyl alcohols having a mass-average degree of polymerization of 600 to 2000 and an average degree of hydrolysis of 86 to 96 mol %, or of fully hydrolyzed standard polyvinyl alcohols having a mass-average degree of polymerization of 600 to 3500 and an average degree of hydrolysis of 96.1 to 99.9 mol %, or of modified polyvinyl alcohols, more particularly of ethylene-modified polyvinyl alcohols, having a mass-average degree of polymerization of 500 to 4500 and an average degree of hydrolysis of 94.5 to 99.9, or hydroxyethylcellulose with viscosities, in 2% strength by weight aqueous solution, of ≦1500 mPas; or mixtures of the stated protective colloids, and 0.8% to 6% by weight, based on the total weight of all monomers, of solvents, and optionally 1% to 3.5% by weight, based on the total weight of all monomers, of one or more anionic sulfosuccinic esters of the general formula (I) to be used; and for 15% to 50% by weight of the vinyl acetate, based on the total weight of the entirety of vinyl acetate used; 50% to 75% by weight of the ethylene, based on the total weight of the entirety of ethylene used; 100% by weight of one or more protective colloids, based on the total weight of the entirety of protective colloids used; 0% to 50% by weight of one or more solvents, based on the total weight of the solvents, a portion of the reducing agent component, and optionally 50% to 85% by weight of one or more emulsifiers, based on the total weight of the entirety of emulsifiers used, to be included in the initial reactor charge prior to initiation; and for the initial reactor charge to be adjusted to a pH between 3 and 5 and heated to a starting temperature of 10° C. to 60° C. The reaction can subsequently be initiated by parallel metering of hydrogen peroxide oxidizing agent and Na formaldehyde-sulfoxylate, Brüggolit® or Brüggolit® FF6 reducing agent, and continued a short time after exothermic start of reaction with uniform parallel metering of vinyl acetate, ethylene, water, solvent, optionally emulsifiers, and ongoing redox initiator feeds. The metered feeds of ethylene, solvent, and optionally emulsifiers may end with the vinyl acetate feed; the metered feeds of ethylene, solvent, and optionally emulsifiers are preferably ended before the end of the vinyl acetate feed. In particular it is advantageous to end the metered feeds of solvent and optionally emulsifiers at a fraction of just 50% to 75% by weight of the metered vinyl acetate fraction. After the end of vinyl acetate metering, the redox initiator feeds continue, optionally at increased rates, in the full polymerization phase, until the exothermic reaction subsides and/or the amount of unreacted vinyl acetate has dropped to less than 2% by weight, preferably to less than 1% by weight, based on the total amount of aqueous dispersion. Subsequently, in the reactor, when the reactor contents are transferred to a downstream vessel, or in that downstream vessel, the fraction of unreacted monomer is reduced to at least less than 0.1% by weight, based on aqueous dispersion, by means of post polymerization, with addition of further redox initiator components, and/or by common steam stripping.

The aqueous dispersions obtainable in this way of the vinyl acetate-ethylene copolymers have a solids content of generally ≧56%, preferably ≧58%. The viscosity of the aqueous dispersions is generally between 1000 and 20 000 mPas, preferably between 2000 and 10 000 mPas, determined as Brookfield viscosity Bf20, at solids contents of 60% and at 23° C.

The emulsion polymerization can also be carried out in the presence of a preformed polymer dispersion, often referred to as seed latex or seed. It is possible, for example, to use as seed a vinyl acetate-ethylene copolymer produced by means of the process of the invention, and to include some or all of the seed in the initial charge or in a metered feed. For obtaining the advantageous effects obtained in accordance with the invention, however, it is not necessary, advantageously, to use a seed. For this reason, the cost and complexity entailed by the use of a seed can be dispensed with in the procedure according to the invention.

During the emulsion polymerization it is possible for the common chain transfer agents to be used. Preferably, however, no chain transfer agents are used. More particularly, besides the listed monomers, protective colloids, optionally emulsifiers, and solvents, no regulator substances with transfer constants for vinyl acetate Cₛ>100*10⁻⁴ are added; transfer constants for the polymerization of vinyl acetate in relation to various substances are listed for example in “Vinyl Polymerization”, Part I, Ed. G. E. Ham, Marcel Dekker, New York 1967, Chapter 4. Polymerization takes place with particular preference in the absence of aldehyde and mercapto transfer agents. The use of chain transfer agents leads to copolymers which when employed as adhesives surprisingly possess a relatively low cohesion.

The average molecular weight of the vinyl acetate-ethylene copolymers was characterized, as is customary and widespread in industrial practice, by the K value of Fikentscher (H. Fikentscher, Cellulosechemie 13(1932)58; cf. also in W. Philippoff: Viskosität der Kolloide [Viscosity of colloids], Verlag von Theodor Steinkopff, 1942, p. 172), obtained from viscosity measurements in compliance with DIN 51562. The K value of the vinyl acetate-ethylene copolymers is generally 65≦K value≦130, preferably 75 to 125, more preferably 85 to 125, and more particularly 90 to 120. The Fikentscher K value correlates with the intrinsic viscosity [η] according to Staudinger (cf., e.g., P. J. Flory, Principles of Polymer Chemistry, Cornell University Press, 1953, p. 308 ff); in accordance with the invention this viscosity is therefore 0.88≦[η]≦3.18 dl/g, preferably 1.14 dl/g≦[ηn]≦2.96 dl/g, more preferably 1.44 dl/g≦[η]≦2.96 dl/g, and more particularly 1.60 dl/g≦[η]≦2.74 dl/g.

Surprisingly it has been found that the solvents used in accordance with the invention, especially the alkyl alcohols, have a comparatively small influence on the K value and generally do not lower it below K values of 90.

Surprisingly, by the process of the invention, vinyl acetate-ethylene copolymers have been obtained which as adhesives or employed as adhesives, in comparison to conventional vinyl acetate-ethylene copolymers, lead to an increase in the adhesion even on critical substrates, such as polymer substrates exemplified by polystyrene films or polyethylene terephthalate films, and at the same time the cohesion of the adhesive film meets the stated minimum requirement of preferably at least 0.2 N/mm², more particularly at least 0.5 N/mm², and in some cases significantly higher cohesion values, and therefore produce a level of properties with high cohesion and high adhesion. A particular surprise was that in the presence of solvents, especially of alkyl alcohols, even in the absence of emulsifiers, the adhesion in the bonded assembly is significantly increased without at the same time the cohesion of the adhesive film reducing in the same way as is known for the use of emulsifiers from DE-A 102009001097. A decisive influence over these effects was exerted by the use of the solvents, more particularly of the alkyl alcohols, and by the amount thereof used during the emulsion polymerization. Subsequent addition of solvent, especially of alkyl alcohol, after the end of the emulsion polymerization does not produce these inventive effects or produces them, if at all, then to a substantially lesser extent. Similarly, the effects of the invention are achieved not at all, or, if so, then to substantially lesser extent, by subsequent addition of the anionic sulfosuccinic esters.

Through the inventive use of solvents, more particularly of alkyl alcohols, and optionally through inventive use of anionic sulfosuccinic esters of the general equation (I) in processes of emulsion polymerization, another effect achieved, in particular, is that with the vinyl acetate-ethylene copolymers obtainable in accordance with the invention, as or in adhesives, it is possible for a multiplicity of different polymer substrates, particularly such critical polymer substrates as polystyrene or polyesters, to be bonded in the desired way with a level of properties with high cohesion and high adhesion.

The inventive fraction of ethylene and/or vinyl acetate in the vinyl acetate-ethylene copolymers also has substantial influence over adhesion and cohesion and also over the level of properties with high cohesion and high adhesion. When using vinyl acetate-ethylene copolymers with a relatively low ethylene content, such as with an ethylene content of <18% by weight, for example, these properties fall off dramatically in comparison to the results achieved in accordance with the invention. When solvent, such as alkyl alcohol, is used at more than 20% by weight, based on the total weight of the monomers, no further positive effects in the boosting of adhesion are achieved, and such higher quantities used are then disadvantageous in relation to optional desired subsequent removal from the vinyl acetate-ethylene copolymers.

The advantageous adhesion and cohesion effects and the level of properties with high cohesion and high adhesion can be boosted still further by the distribution of vinyl acetate, ethylene, optionally emulsifier, solvent, especially alkyl alcohol, and protective colloid between initial charge and metered feed. A particular surprise was that when the solvents, especially the alkyl alcohols, were distributed between initial charge and metered feed, for a given fraction of solvent, it was possible in some cases to boost further the effects of an improvement in adhesion, with the cohesion being maintained at a high level at the same time.

The vinyl acetate-ethylene copolymers of the invention are suitable for use as or in adhesives for the bonding of any desired substrates, preferably of cellulosic materials, such as paper, cardboard, wood, or plastics, such as polyethylene, polyvinyl chloride, polyamide, polyesters, polystyrene, or acrylonitrile-butadiene-styrene. The substrates may be, for example, fibers, films, or else moldings. Corresponding fields of application of the adhesives are, more particularly packaging materials or woven or non-woven fiber materials.

The vinyl acetate-ethylene copolymers are particularly suitable as or in adhesives for the bonding of cellulosic substrates, more particular paper, cardboard or woven cotton fabric, to plastics, such as polyethylene, polyvinyl chloride, polyamide, polyesters, polystyrene or acrylonitrile-butadiene-styrene, more particularly in the form of polymeric films, or for the bonding of two plastics to one another, as for example for film/film bonds.

The vinyl acetate-ethylene copolymers are also suitable, however, for other common applications of such polymers, such as, for example, as binders and/or coating materials more particularly for fibrous substances or structures, as for example in the area of wovens or, preferably, nonwovens as fabrics.

The vinyl acetate-ethylene copolymers of the invention are suitable, optionally with addition of further amounts of protective colloids and customary adjuvants, as well for the production of water-redispersible polymer powders, more particularly by spray drying, and can be used as such in the form, for example, of additives in the construction industry for cementitious and noncementitious applications, in order to improve adhesive properties. It is possible to employ the common techniques and apparatus in order to convert the products of the emulsion polymerization of the invention, by means of drying, into water-redispersible polymer powders.

A particular surprise was that through the procedure according to the invention it was possible to achieve the level of properties with high cohesion and high adhesion even for the bonding of substrate combinations that are particularly critical in this respect, such as for bonding of plastics, more particularly of polystyrene films or polyester films, such as polyethylene terephthalate, to one another or to cellulosic materials, such as paper, cardboard, or woven cotton fabric.

Accordingly, adhesive films of the vinyl acetate-ethylene copolymers of the invention preferably exhibit cohesion values, measured as thermal stability, of at least 0.2 N/mm², preferably of 0.5 N/mm², and preferably at the same time the following high adhesion values even in the case of difficult-to-bond substrates:

Sidaplax® Polyflex 90 polystyrene film bonded to cotton using vinyl acetate-ethylene copolymers of the invention preferably exhibits a peel strength of at least 3.8 N/cm, more preferably at least 4 N/cm, at a peel rate of 5 mm/min, and Hostaphan® RN125 polyethylene terephthalate film bonded to cotton using vinyl acetate-ethylene copolymers of the invention exhibits preferably a peel strength of at least 3.4 N/cm, more preferably at least 4 N/cm, at a peel rate of 10 mm/min, or preferably a peel strength of at least 1.2 N/cm, more preferably at least 1.5 N/cm, at a peel rate of 900 mm/min.

Simultaneously, with the vinyl acetate-ethylene copolymers of the invention, with a level of properties with high cohesion and high adhesion, a cumulative adhesion, CA, of preferably not more than 18 seconds, or less, is achieved. Furthermore, the aqueous dispersions of the invention of the vinyl acetate-ethylene copolymers possess a high setting rate for the adhesive film, which, measured as tack speed (TS), achieves values of preferably 3 seconds or less. The individual methods, conditions, and materials for determining the parameters in terms of the cohesion, adhesion, and tack speed are described in detail later on below under the heading “Test methods for determining the adhesives properties”.

The examples which follow serve to elucidate the invention, without restricting it to the recited examples.

Described first of all are the test methods for characteristic dispersion values, and the test methods for determining the adhesives properties:

### Test Methods for Characteristic Dispersion Values:

### Solids Content/Drying Residue (SC-Ex):

To determine the solids content experimentally, in percent based on dispersion, 0.3 g of polymer dispersion was weighed out and dried as a thin film for 30 minutes at 150° C. in a forced-air drying cabinet. The drying residue was weighed again, after cooling in a desiccator over silica gel, and the solids content in % by weight, based on dispersion, was calculated from residue and initial mass. Results for experimental solids contents SC-Ex are reported in table 3.

### Viscosity (Bf20-Ex):

The viscosity of the dispersion was measured, following conditioning at 23° C., using a Brookfield viscometer, and using the optimum spindle for the particular level of viscosity, at 20 rpm. The viscosity is reported in mPas. For greater ease of comparability, the viscosity values measured at the experimental solids content, SC-Ex, i.e., BF20-EX, have been converted for a solids content of 60%: With satisfactory approximation, the relationship for the polymer dispersions investigated here is as follows:

Bf20 (60%)=(Bf20-EX)*EXP (0.5*(60-(SC-EX))).

Results obtained are reported in table 3.

Particle Sizes (x_{3,50}):

To determine a particle size distribution with the Beckmann Coulter® LS 13 320 instrument in accordance with the instrument instructions, using the optical constants for polyvinyl acetate, the dispersion was diluted with water. The particle size reported here is the central value of the volume distribution function of the particle diameter x_{3,50} in nanometers. The particle size distributions determined exhibit substantially monomodal distribution densities, whose modal value is close to the central value of the distribution. Results obtained are reported in table 3.

### Sieve Residue (Grit):

The residue of the dispersion, reported in parts per 10⁶, based on dispersion (ppm), characterizes coarsely granular fractions in the dispersion, with dimensions of more than 40 μm. In order to determine fractions of this kind, which are unwanted and must be minimized, 100 grams of the dispersion were diluted with up to one liter of distilled water, and then poured through a nylon fabric sieve having a mesh size of 150 μm, and the undersize was filtered through a fabric sieve with a mesh size of 40 μm. Rinsing with water was continued in each case until the undersize was clear. The residue on the fabric sieves was dried and then weighed, and a calculation was made of the sieve residue per fabric sieve, based on dispersion. In table 3 the total residue on both sieves greater than 40 μm has been reported.

It should expressly be mentioned that the reporting of residue>40 μm is a very critical evaluation of the sieve residue. Customary within industry are data>50 μm or >60 μm. From experience, in the range between 40 μm and 60 μm, around 20% to 50% of the residue may be situated between 40 μm and 150 μm. For the majority of applications it is necessary and sufficient for the sieve residue to adopt >40 μm values of <1000 ppm, preferably of <800 ppm. Results obtained are reported in table 3.

### K Value and Intrinsic Viscosity:

The dispersion was weighed out into a 50 ml volumetric flask to produce a dispersion sample which contained 0.5 g of polymer (without polyvinyl alcohol) and 4 g of water. Tetrahydrofuran (THF) was slowly added dropwise with stirring until a clear solution was produced. Following conditioning at 23° C., the flask was made up to the mark with THF. The measurement solution had a concentration of 1 g of polymer per 100 ml of solution. Taking account of the Hagenbach correction, the viscosity of a gel-free sample of the measurement solution and of the polymer-free comparative solution was determined in an Ubbelohde viscometer (capillary 1c) at 23° C. to ascertain the relative solution viscosity ηᵣₑₗ. Using this figure, the “inherent viscosity k” of Fikentscher, Cellulosechemie 13 (1932) 58, and the “K value”, at K=1000 k, were calculated. The inherent viscosity k is given by:

$$k = \frac{1}{2} ( \frac{1.5 {c}_{V} log {η}_{rel} - {c}_{V}}{1.5 {c}_{V}^{2} + 75 {c}_{V}} ) + {[ {( \frac{1}{2} ( \frac{1.5 {c}_{V} log {η}_{rel} - {c}_{V}}{1.5 {c}_{V}^{2} + 75 {c}_{V}} ) )}^{2} + \frac{log {η}_{rel}}{1.5 {c}_{V}^{2} + 75 {c}_{V}} ]}^{1 / 2} ,$$

using the concentration C_{V} in g/dl.

The K value is a customary and useful parameter which correlates with the viscometric average molar mass of the polymer.

The K value is of course dependent on the copolymer composition and generally decreases as the ethylene content of a vinyl acetate-ethylene copolymer goes up.

The K value thus determined can be used, with the specified equation, to calculate the concentration dependency of the relative viscosity. From this, by calculation, the dependency of the quotient (η_{S}/C_{V}), made up of specific viscosity, η_{S}=(ηᵣₑₗ−1), and concentration, C_{V}, follows from the concentration. Extrapolation—advantageously by means of exponential function—to infinite dilution gives the intrinsic viscosity [η]. The concentration here is set in grams per 100 ml of solution, in other words in g/dl—that is, [η] here is in dl/g.

The results for K value and intrinsic viscosity [η] are reported in table 3.

### Test Methods for Determining the Adhesive Properties:

### Setting Rate (TS Method):

During the setting of a dispersion which is suitable as an adhesive, the strength of the bond increases over time. The rate of the setting process can therefore be described by a change in the strength of an adhesive film as a function of time. Using the method of tack speed (TS), a determination is now made of the time during which a bond area of 1 cm² withstands an acceleration-free perpendicular tensile force of 2 newtons. For the bond, standard card-index cardboard from Koehler Feinpapiere was coated with a 50 μm film of dispersion and bonded to a circular section of the same cardboard, measuring 1 cm². After different times, the resistance of the bond to the perpendicular tensile force of 2 N was tested, and in this way a determination was made of the time in seconds during which the bond retains its integrity. The result is reported as TS in seconds. Falling TS values for different dispersions, accordingly, characterize increasing setting rates. A requirement for sufficiently rapid setting is that the setting rate by the TS method is to be ≦3 seconds. Results obtained are reported in table 3.

### Cohesion:

12 plywood blocks (135×30×4 mm) were used to produce 6 test specimens each with a bonded area of 9 cm². To produce the bonds, pairs of blocks were each given a layer of dispersion of 100 μm over a length of 30 mm and joined without pressure for 1 minute. Thereafter the bond was loaded for 30 minutes with a pressing pressure of 0.2 N/mm². The test specimens were then stored at 23° C. and 50% humidity for 7 days and prior to testing were conditioned in a forced-air drying cabinet at 70° C. for 4 hours. The strength of the bond was then determined immediately in the hot condition with a tensile testing machine, at a peel rate of 50 mm/min, until the bond fractured. The maximum force at fracture, based on the area of the bond, is reported as the bonding strength (cohesion) in N/mm². The result for the cohesion that is specified is the average value of the tests on all 6 test specimens, rounded to an accuracy of one decimal place. The requirement is for cohesion values of at least 0.2 N/mm², preferably at least 0.3 N/mm², and more particularly at least 0.5 N/mm². Results of the cohesion testing are reported in table 4.

### Cumulative Adhesion:

Strips of soda kraft paper, bleached smooth on one side, white, 60 g/m², 10×50 mm, were each coated with a 50 μm layer of the dispersion under test, on the rough reverse of the paper, and adhered to 7 different polymeric films (film 1: polyvinyl dichloride film from PKL Flexible Verpackungen, PVDC1-coated side is bonded; film 2: rigid PVC transparent film 250 μm from Pütz GmbH & Folien K G; film 3: flexible PVC film H068/200 μm from Pütz GmbH & Folien K G; film 4: flexible PVC Alkor blue film 40 μm from Alkor GmbH; film 5: cast polyamide film PA 6/100 μm from Petopa Verpackungsfolien Handels GmbH; film 6: Hostaphan® RN36 polyester film from Pütz GmbH & Folien

KG; film 7: cellulose diacetate N50/50 μm film from Pütz GmbH & Folien K G). After a drying time of 2 hours, the test strips were peeled off by hand and the adhesive strength (adhesion) was assessed as follows:
1: very good adhesion, 100% paper tear
2: good adhesion, predominantly paper tear
3: adhesion, separation with resistance
4: no adhesion, delamination

The 7 assessment values were added to give the cumulative adhesion, which can therefore vary between 7 (very good adhesion to all 7 substrates) and 28 (no adhesion to any of the substrates). The cumulative adhesion is to be ≦18, preferably ≦17. Results for the cumulative adhesion CA are reported in table 4.

### Adhesion (Peel Strength):

For a quantitative determination of the adhesion, a Sidaplax® Polyflex 90 film was used as polystyrene substrate PS, and a Hostaphan® RN125 film as polyethylene terephthalate substrate.

A bonded assembly was produced with a standard cotton fabric, with the WFK code 10A according to DIN53939.

For this purpose, both the cotton fabric and the film were coated with the aqueous dispersion using a 100 μm wire applicator. The two coated substrates were then laminated manually and compressed with the aid of a rubber-coated metal roller (3.5 kg). After bonding had taken place, the test specimens were each dried for 24 h under standard conditions (23° C. and 50% relative humidity).

To produce the bonded assembly between polystyrene and cotton, ready-cut strips 2.5 cm wide of the cotton fabric were bonded centrally over a length of 15 cm to Sidaplax® Polyflex 90 film strips 4.8 cm wide (5 cm remain unbonded).

To produce the bonded assembly between polyethylene terephthalate and cotton, DIN A4-sized areas of the cotton fabric were each bonded to Hostaphan® RN125 film (5 cm remained unbonded on one transverse side), and then, after drying, strips 2.5 cm wide were cut lengthwise from these bonds, using a cutting machine, as test specimens.

To test the adhesion (peel strength), the cotton fabric was delaminated from the film in a tensile tester instrument. This was done by clamping the unbonded sections of the strips and peeling the cotton fabric from the polymer film at a peel angle of approximately 180 degrees. The peel tests were carried out on the day after drying of the bonded assembly.

To determine the adhesion to polystyrene (Adh PS), a peel rate of 5 mm/min was selected. Over a measurement path of 60 mm, the delamination force (tear propagation resistance) between 20 and 60 mm was measured and averaged.

To determine the adhesion to polyethylene terephthalate, two different measuring speeds were selected: a low peel rate of 10 mm/min (slow peel, Adh PET1), and a high peel rate, at 900 mm/min (fast peel, Adh PET2). For the low peel rate, a 60 mm measurement path was set, with the tear propagation resistance between 20 and 60 mm being measured and averaged. At the higher measuring speed of 900 mm/min, a measurement path of 150 mm was set, with the tear propagation resistance between 20 and 150 mm being measured and averaged.

The high peel rate for PET film, of 900 mm/min, was additionally selected since weaknesses in terms of adhesion are manifested with particular clarity at a high peel rate.

For each substrate and peel rate, 8 bonds were respectively delaminated. The adhesion (peel strength) is obtained from the averaged tear propagation resistances for all the strips and from the strip width of 2.5 cm in each case, and is reported in N/cm rounded to an accuracy of one decimal place.

It is desired for the following adhesion values at least to be attained:

Adh PS=3.8 N/cm and Adh PET1=3.4 N/cm and Adh PET2=1.2 N/cm.

Preferred values are in each case at least:

Adh PS=4.0 N/cm and Adh PET1=4.0 N/cm and Adh PET2=2.0 N/cm.

Particularly preferred values are in each case at least:

Adh PS=4.2 N/cm and Adh PET1=4.1 N/cm and Adh PET2=2.5 N/cm.

And in particular it may be advantageous to attain the following adhesion values:

Adh PS=5.0 N/cm and Adh PET1=4.1 N/cm and Adh PET2=2.5 N/cm.

Results for Adh PS, Adh PET1, and Adh PET2 are reported in table 4.

### EXAMPLES

### Comparative Examples C1 and C2

For the comparative examples C1 and C2, two commercially available vinyl acetate-ethylene copolymer dispersions were tested that are known for their good adhesion properties. The results are reported in table 4.

### Comparative Example C1

Mowilith® DM132 is a vinyl acetate-ethylene copolymer dispersion, stabilized in the presence of polyvinyl alcohol, from Celanese Corp., which corresponds to the prior art.

### Comparative Example C2

Vinnapas® A920 is a vinyl acetate-ethylene copolymer dispersion, stabilized in the presence of polyvinyl alcohol and APEO emulsifier from Wacker Chemie AG, which corresponds to the prior art.

### Inventive and Comparative Examples

The aqueous emulsifier solutions used in the inventive and comparative examples are characterized in table 1 with regard to their chemical composition, fraction of solvent, especially of alkyl alcohol, and also in respect of the concentration of active emulsifier substance.

In the comparative examples C3, C4, C5, C6, C7A, C7B, C7C, C7D, and C7E, polymerization took place without use of emulsifiers.

In comparative examples C3 to C11, polymerization took place without separate addition of solvents, especially alkyl alcohols; during the polymerization, amounts of alkyl alcohol that were nevertheless present of <0.04% by weight, based on the total weight of the monomers, resulted from corresponding fractions of alkyl alcohol in the polyvinyl alcohol employed.

For inventive examples 1 to 26, essentially different fractions of polyvinyl alcohol and different amounts of inventively employed anionic sulfosuccinic esters of the general formula I, and also of inventive solvent, especially alkyl alcohol, were used for the polymerization; furthermore, the vinyl acetate and ethylene monomers, the sulfosuccinic esters used, and the alkyl alcohol employed were distributed in different proportions between the initial reactor charge and the metered feed. Inventive example 19 contained, alternatively, a nonionic emulsifier.

The polymer dispersions were prepared using the general polymerization procedure below. Table 2 contains the detailed information on the variations to this procedure for the individual examples.

General polymerization procedure for comparative examples C3 to C11 and for inventive examples 1 to 26:

The polymerizations were each carried out in a 2 liter pressure reactor which was equipped with a three-stage paddle stirrer, jacket heating and jacket cooling, connected to a regulable thermostat, and metering ports for the following metered feeds: metered feed 1 was an aqueous solution of the oxidizing agent in the redox initiator system, metered feed 2 was the aqueous solution of the reducing agent in the redox initiator system, metered feed 3 was the vinyl acetate monomer, metered feed 4 was an aqueous solution comprising alkyl alcohol and optionally emulsifier (for the comparative examples, consisting only of water, without alkyl alcohol and without emulsifier), and metered feed 5 was the ethylene monomer.

For the course of the polymerization, the following process steps were maintained:

### Preparation of Initial Reactor Charge:

First of all the aqueous initial charge was prepared, consisting of
initial charge water,
aqueous protective colloid solution, prepared separately according to generally known methods,
alkyl alcohol and emulsifier (where introduced into the initial charge),
5% by weight of the reducing agent used in metered feed 2.

The pH of the aqueous initial charge was monitored and adjusted to a pH of 3.5±0.1 generally by addition of phosphoric acid or formic acid (formula amount 10 g).

Thereafter 0.4% by weight of a 1% strength by weight iron ammonium sulfate solution were added to the initial charge, based on the total monomer amount, and this aqueous initial charge was drawn under suction into the evacuated reactor, followed by 30 g of water to rinse the line.

Then, with stirring, the vinyl acetate was drawn under suction into the initial charge in the reactor, followed by 40 g of water to rinse the line.

The reactor was then heated to the setpoint temperature and at the same time the vacuum was broken with ethylene and the initial charge amount of ethylene was injected at the setpoint stirrer speed.

### Initiation of Reaction and Metering Phase:

At temperature and pressure equilibrium, the parallel metered feed of the two initiator components, in the form of metered feeds 1 and 2, was commenced.

5 minutes after the onset of the reaction, apparent from an increase in the internal temperature and drop in the jacket temperature, the two metered feeds 3 and 4 were commenced and were metered in generally at a constant rate over a time of 120 to 180 minutes. Metered feed 4, with a total amount of 80 g (which can be increased to up to 100 g, for example), was ended no later than at the same time as metered feed 3.

15 minutes after the beginning of metered feeds 3 and 4, metered feed 5 was commenced, and was ended about 15 minutes before the end of metered feed 3. The required amount of ethylene was injected at equidistant time intervals in equidistant amounts, generally at intervals of 10 minutes. Metered feed 5 can of course also be metered with a constant mass flow rate. To monitor the course of reaction, the profile of both temperature and pressure was recorded and, from the beginning of metering of metered feed 3, samples were taken from the reactor every 30 to 60 minutes (up to about 10 grams, including rinsing quantities) and their solids content was used to calculate conversion values for vinyl acetate and ethylene.

### Full Polymerization:

After the end of metered feed 3, the rates of metered feeds 1 and 2, which up to that point had generally been constant, were increased in steps to up to 50 ml/h, and metering continued generally for at least 60 minutes; the metered feeds were ended earlier if there was no longer any perceptible reaction. The total amounts of metered feeds 1 and 2 according to formula were in each case 100 g (these amounts can be reduced to down to 65 g, for example). In cases where there was still a perceptible reaction after the end of the time provided for, both metered feeds 1 and 2 were metered on, each with constant rates of 50 ml/h, until there was no longer any perceptible reaction (end of reaction); the full polymerization phase was ended no later than 120 minutes after the end of metered feed 3.

Principally on account of a longer metering time of 60 minutes at most, and hence a higher metering quantity for metered feeds 1 and 2, the final solids content of the dispersion may be less than the formulated solids content; moreover, deviations between the guideline amounts and the actual amounts for pH adjustments may lead to deviations between experimental final solids content (SC-Ex) and formula solids content (SC-F).

### Postpolymerization:

After the end of metered feeds 1 and 2, for the purpose of postpolymerization, 10% strength by weight solutions of Na formaldehyde-sulfoxylate (metered feed 6) and of tert-butyl hydroperoxide (metered feed 7), in alternation and with a total of 4 g each, were in each case metered into the reactor with water rinses totaling 20 g.

### Cooling/Letdown/Adjustment:

After the end of the postpolymerization, the product was cooled to about 30° C. and the reactor contents were let down. With addition of 10% strength by weight aqueous sodium hydroxide solution (formula amount 5 g), the pH was adjusted to about 5.5. Where solids content values of ≦62% were ascertained (in the case or premature end of reaction), the product was diluted to a solids content of about 60% to 60.5% by addition of water.

### Further Details:

In general, metered feed 1 used was a 2% strength by weight hydrogen peroxide solution, and metered feed 2 was a 9% strength by weight Na formaldehyde-sulfoxylate solution (Brüggolit®).

The amount of initial charge water was a product of the concentration of the protective colloid solution used, the formulated solids content, and the fill level of the reactor at the end of reaction, which, without taking account of the samplings, was generally set at between 90% and 96% by volume. The total amount of monomer used in initial charge and metered feeds was 1100 grams for all examples.

The water used, including that used to prepare the solutions for metered feeds 1, 2, 4, 6, and 7, was exclusively fully demineralized Wofatit water.

In metered feed 4, various emulsifiers were employed, all of which are set out in table 1.

Solvents, especially alkyl alcohol(s), more particularly ethanol or 2-propanol, were introduced into the initial charge and metered feed 4 in accordance with their proportion in the emulsifier specimens according to table 1 and the emulsifier fraction selected for the polymerization; additional fractions of alkyl alcohol were used in the form of ethanol in proportion to the emulsifier fraction in the initial charge and metered feed 4, or, independently of the emulsifier fraction, were used only in metered feed 4: For examples 2, 5, 6, and 7, the only alkyl alcohol present during the polymerization was that introduced with the respective emulsifier specimens in accordance with table 1. For examples 4, 8, 9, and 11, the respective emulsifier specimens were diluted to 25% by weight active emulsifier substance in each case, by addition of water and ethanol, and were distributed between initial charge and metered feed 4, thus giving the values reported in table 2 for the emulsifier fraction (columns 9 and 10) and alkyl alcohol fraction (columns 7 and 8).

For examples 1, 3, and 10 and also for the emulsifier-free examples 12, 13, 14, 17, 18, 20, and 21, additional alkyl alcohol in the form of ethanol was used exclusively in metered feed 4. For the likewise emulsifier-free examples 15 and 16, solvent, especially alkyl alcohol, was added entirely to the initial reactor charge before the initiation was commenced, and, for the emulsifier-free examples 22 to 26, added solvent, especially alkyl alcohol, was distributed between initial charge and metered feed 4.

For the comparative examples C7A to C7E, polymerization took place without addition of emulsifiers and without addition of solvent, with the ethylene fraction as a proportion of the total monomer being varied between 19% and 32% by weight; accordingly, there was a reduction in the fraction of vinyl acetate monomer, with always 50% of the total ethylene and 25% of the total vinyl acetate monomers being included in the initial reactor charge.

The protective colloid used was a low molecular mass standard polyvinyl alcohol having a mass-average degree of polymerization of 850 and an average degree of hydrolysis of 88 mol %; the amount of methanol for this ingredient was 1% by weight, based on the weight of ingredient.

Table 2 summarizes the formula data. As illustrated with the details in table 2, for fractions of polyvinyl alcohol, based on total monomer, of 2.5%, 3.0%, and 3.5% by weight, the ethylene fraction was varied between 19% by weight and 32% by weight, with between 40% and 100% of the ethylene and 15% to 50% of the vinyl acetate being included in the initial reactor charge. The emulsifier fraction, based on total monomer, was varied between 0% by weight for the emulsifier-free inventive and comparative examples, and 3.5% by weight, with between 65% and 100% of the emulsifier being included in the initial charge. For inventive examples 1 to 26, the fraction of inventive anionic emulsifiers was varied between 1.4% and 3.5% by weight, and the fraction of alkyl alcohol was varied between 0.2% and 5.0% by weight, based in each case on the total monomer amount. The fraction of inventively used solvent, especially alkyl alcohol, in the initial charge varied between 0% and 100% by weight, based on the amount of alkyl alcohol used.

The polymerizations were conducted at temperatures between 50° C. and 70° C. reaction temperature, with the reaction mixture being stirred, thus ensuring homogeneity of the reaction mixture and removal of heat. For this purpose, speeds in the 2 liter reactor of between 500 and 600 rpm were sufficient. The setpoint speed was not altered during the reaction. The setpoint temperature at the beginning of metered feeds 1 and 2 can be lowered down to 30° C. to 40° C., and the heat of reaction can be utilized for further heating of the reaction mixture. It was found that the temperature profile of the polymerization in the specified range has no significant influence on the adhesives properties of the products.

Indicated by way of example is the formula of emulsifier-free comparative example C4:

### Initial Reactor Charge:

204.5 g of water,

137.5 g of polyvinyl alcohol solution (20% strength by weight),

6 g of Brüggolit (9% strength by weight solution),

10 g of phosphoric acid (10% strength by weight solution), guideline value for pH adjustment pH=3.5,

4.5 g of iron ammonium sulfate (1% strength by weight solution),

30 g water rinse,

240 g of vinyl acetate,

40 g water rinse,

150 g of ethylene,

heating to setpoint temperature of 60° C.; speed 600 rpm.

### Metered Feed 1:

100 g of hydrogen peroxide (2% strength by weight aqueous solution)

### Metered Feed 2:

100 g of Brüggolit (9% strength by weight aqueous solution)

### Metered Feed 3:

560 g of vinyl acetate (metered at constant rate over 2 hours)

### Metered Feed 4:

100 g of water (metered at constant rate over 2 hours)

### Metered Feed 5:

150 g of ethylene (injected uniformly at intervals over about 90 minutes)

### Metered Feed 6:

4 g of Brüggolit® (10% strength by weight aqueous solution)

10 g water rinse

### Metered Feed 7:

4 g of tert-butyl hydroperoxide (10% strength by weight aqueous solution)

10 g water rinse

### Adjustment:

5 g of sodium hydroxide (10% strength by weight aqueous solution)

According to formula and assuming full monomer conversion, this resulted in 1866 g, corresponding to 1759 ml of polymer dispersion with a formula solids content of 61.2% by weight for a final reactor fill level of around 90% by volume.

The procedure for comparative examples C3 and C5 to C10 and for inventive examples 1 to 26 was in accordance with this, taking account of the details relating to the polymerization process and the details in table 2.

Polymer dispersions obtained by the stated polymerization process were analyzed for characteristic dispersion values. Results of these analyses are reported in table 3.

All of the polymer dispersions of comparative examples C1 to C11 and of inventive examples 1 to 26 were likewise investigated for their adhesives properties. The results obtained in these investigations are compiled in table 4.

Discussion of the adhesives properties of the dispersions prepared according to the examples, on the basis of the results summarized in table 4:

### Comparative examples C1 and C2

The product of comparative example C1 gave good cohesion, but the adhesion values on PET, especially in the case of rapid peel removal, Adh PET2, are much too low.

The product of comparative example C2 gave very good adhesion values, but the cohesion is far to low and therefore fails by a long way to meet the requirements.

### Comparative Examples C3 to C6 (Without Emulsifier and Without Inventive Amounts of Solvent, Especially Alkyl Alcohol)

These products, prepared in the absence of emulsifier and of inventive amounts of alkyl alcohol with different ethylene fractions and different distributions of ethylene and vinyl acetate between initial charge and metered feeds, led to excellent cohesion values, of the kind known from the prior art for vinyl acetate ethylene copolymers, stabilized exclusively in the presence of polyvinyl alcohol; overall, however, the adhesion values for bonds to PS and PET film with cellulosic substrate do not meet the stipulated requirements.

### Comparative Examples C7A, C7B, C7C, C7D, and C7E

For these comparative examples, the ethylene fraction of the vinyl acetate-ethylene copolymers was varied between 19% and 31% by weight and polymerization was carried out in substantial absence of solvent. The examples demonstrate that as the fraction of ethylene went up, the adhesion to polyester substrate did in fact increase on rapid removal, Adh PET2, starting from low values, while the cohesion took on virtually constant values, but that increasing ethylene fractions did not overall lead, generally, to an improvement in adhesion: For polystyrene substrate, accordingly, the adhesion decreased again above about 28% by weight ethylene, and the data for the cumulative adhesion, CA, deteriorated generally with increasing ethylene fractions. The results for the cohesion values were dependent at best only slightly on the ethylene fraction, and overall were at a high level. These examples demonstrate that a level of properties with high cohesion and high adhesion cannot be brought about solely by altering the ethylene fraction in vinyl acetate-ethylene copolymers.

### Comparative Examples C8 to C10

For these comparative examples, noninventive anionic emulsifiers and noninventive amounts of alkyl alcohol were used. The polymer dispersions obtained possess good cohesion values, but, overall, the adhesion values do not meet the stipulated requirements in terms of a level of properties with high cohesion and high adhesion. Example C9 does achieve effective adhesion to PS film, but the adhesion to PET film is far too low.

### Comparative Example C11 and Inventive Example 1

The use of inventive anionic monoester of sulfosuccinic acid in the absence of inventive amounts of alkyl alcohol, in example C11, leads to effective cohesion and effective adhesion to PET film, but the adhesion to PS film is still too low. This deficit is remedied in inventive example 1 by the inventive presence of alkyl alcohol. With inventive example 1, all of the requirements in terms of adhesives properties are met, and a level of properties with high cohesion and high adhesion is achieved. Comparing the adhesives properties of the polymer dispersion from inventive example 1 with those from comparative example C4, which was implemented under the same conditions but in the absence of emulsifier and of inventive amounts of alkyl alcohol, demonstrates the significant improvement in adhesive properties through simultaneous use of anionic sulfosuccinate and alkyl alcohol.

### Inventive Examples 2 to 11

These examples demonstrate the adhesives properties achievable through use of inventive emulsifiers and inventive simultaneous presence of alkyl alcohol(s), and especially the achievable and adjustable level of properties with high cohesion and high adhesion. Inventive examples 2 and 3 are based on comparative example C5, which was implemented without emulsifier and alkyl alcohol. Inventive examples 4, 5, 7, 9, 10, and 11 are based on comparative example C4, which was implemented without emulsifier and alkyl alcohol. Inventive example 6 is based on comparative example C6, which was implemented without emulsifier and alkyl alcohol, and inventive example 8 is based on comparative example C3, which was implemented without emulsifier and alkyl alcohol. For all of the inventive examples, it is obvious from table 4, in comparison with the associated comparative examples, that when the inventive anionic emulsifiers are used, and in the simultaneous presence of inventive amounts of alkyl alcohol(s), the values for adhesion both to PS film (column 5) and to PET film (column 6) are increased significantly to at least 4.0 N/cm, without an accompanying reduction in the cohesion (column 3) below the required minimum value of 0.2 N/mm².

A particular surprise was that the poorly water-soluble anionic diester of sulfosuccinic acid, which becomes increasingly water-insoluble as the C number in the alkyl radical goes up, leads to effective cohesion and effective adhesion both to PS substrate and to polyester substrate, even with a low level of use (inventive examples 9 and 10) or else without additional use of alkyl alcohol (inventive examples 5, 6, and 7) during the polymerization—and therefore not beyond the fraction which is introduced in each case by the emulsifier specimens according to table 1—and that polymer dispersions prepared in this way meet all of the stipulated requirements.

### Inventive Examples 12 to 18

These examples are based on comparative example C4, for which neither emulsifiers nor inventive amounts of alkyl alcohol were used. Inventive examples 12, 13, 14, 17, 18, and 20 were prepared likewise in the absence of emulsifiers, but with different amounts of inventive alkyl alcohol, introduced exclusively via metered feed 4. These examples demonstrate that even in the case solely of inventive use of solvent, especially alkyl alcohol, it is possible to achieve adequate adhesion values even without the presence of emulsifiers, with the adhesive properties improving further if, for small amounts of solvent used, this solvent is introduced first and foremost—as for inventive examples 15 and 16—into the initial reactor charge.

### Inventive Example 19

Inventive example 19 is based likewise on comparative example C4. It demonstrates the significant improvement in adhesion values as a result of the use of inventive fractions of solvent, especially alkyl alcohol, in the presence of a nonionic emulsifier.

### Inventive Examples 20 to 26

The examples were based on comparative example C7D with 28% by weight of ethylene, and demonstrate the inventive effect of the use of solvent, especially of alkyl alcohol, on the adhesive and cohesive properties of the bonded assembly: Inventive examples 20 to 26 demonstrate the achievement of high adhesion values Adh PS, Adh PET1, and Adh PET2, in some cases well above the requisite minimum values, and at the same time of high cohesion values, without the value falling below the requisite minimum value, on inventive use of different amounts of solvent, especially alkyl alcohol, with this solvent being distributed differently between initial charge and metered feed. For inventive examples 20 and 21, solvent, especially alkyl alcohol, was added only to metered feed 4; for examples 22 to 26, alkyl alcohol was distributed between initial charge and metered feed. These examples show more particularly what very good adhesion values were obtainable with increasing amounts of solvent, especially alkyl alcohol, in the preferred range for the amounts used, without an accompanying decrease in the cohesion below a level of 0.5 N/mm², and hence the cohesion being well above the requisite minimum value of 0.2 N/mm².

TABLE 1
Emulsifier specimens—overview of the aqueous
emulsifier solutions used in the examples:

| 1 | | 3 | |
|---|---|---|---|
| Active emulsifier | 2 | Alkyl | 4 |
| substance | Code | alcohol* % | Conc. % |
| Dodecyl sulfate, Na salt | A | 0.0 | 40.0 |
| Ethoxylated (30 EO) fatty | B | 0.0 | 33.0 |
| alcohol (C12-C14) sulfate, Na | | | |
| salt | | | |
| Tallow (C18, C16, C14) | C | 0.0 | 32.2 |
| alkylamine sulfosuccinamate | | | |
| monoester, Na salt | | | |
| Ethoxylated (3 EO) alcohol | D | 0.0 | 32.1 |
| (C12-C14) sulfosuccinate | | | |
| monoester, Na salt | | | |
| Dimethylbutylsulfosuccinate | E | 5.0 | 78.3 |
| diester, Na salt | | | |
| Octylsulfosuccinate diester, | F | 9.0 (*) | 68.0 |
| Na salt | | | |
| Decylsulfosuccinate diester, | G | 10.0 (*) | 45.0 |
| Na salt | | | |
| Decylsulfosuccinate diester, | H | 15.0 (*) | 64.0 |
| Na salt | | | |
| Isotridecylsulfosuccinate | I | 15.0 (*) | 60.0 |
| diester, Na salt | | | |
| Isotridecylsulfosuccinate | J | 21.0 | 70.0 |
| diester, Na salt | | | |
| Isotridecylsulfosuccinate | K | 19.0 | 70.0 |
| diester, Na salt | | | |
| Nonionic oxo-process alcohol | L | 0.0 | 23.6 |
| ethoxylate, C11 branched, | | | |
| 21 EO | | | |

Key to table 1:
Column 2: code: identifying letter of the emulsifier specimen, used in table 2;
Column 3: alkyl alcohol % indicates the fraction of alkyl alcohol in the emulsifier specimen in % by weight, based on amount of emulsifier specimen;
Column 4: conc. % indicates the fraction of active emulsifier substance in the emulsifier specimen in % by weight, based on amount of emulsifier specimen;
(*) identifies 2-propanol; otherwise ethanol.

TABLE 2
Formula data of the examples

| | | | | | | | 8 | | | |
|---|---|---|---|---|---|---|---|---|---|---|
| | | | | | 6 | 7 | Alkyl | | | |
| | 2 | 3 | 4 | 5 | Emulsi- | Alkyl | alcohol | 9 | 10 | 11 |
| 1 | MS | Eth | Eth-IC | VAC-IC | fier | alcohol | % | ME | ME-IC | SC-F |
| Ex. | % | % | % | % | code | % | in. ch. | % | % | % |
| Cl | Commercial product Mowilith DM132 | | | | | | | | | |
| C2 | Commercial product Vinnapas A920 | | | | | | | | | |
| C3 | 2.5 | 22.0 | 100 | 30 | none | <0.03 | 100 | 0.0 | 0 | 61.2 |
| C4 | 2.5 | 27.3 | 50 | 30 | none | <0.03 | 100 | 0.0 | 0 | 61.2 |
| C5 | 2.5 | 27.3 | 50 | 50 | none | <0.03 | 100 | 0.0 | 0 | 60.4 |
| C6 | 3.5 | 32.0 | 40 | 15 | none | <0.04 | 100 | 0.0 | 0 | 61.2 |
| C7A | 3.0 | 19.0 | 50 | 25 | none | <0.03 | 100 | 0.0 | 0 | 61.2 |
| C7B | 3.0 | 22.0 | 50 | 25 | none | <0.03 | 100 | 0.0 | 0 | 61.2 |
| C7C | 3.0 | 25.0 | 50 | 25 | none | <0.03 | 100 | 0.0 | 0 | 61.2 |
| C7D | 3.0 | 28.0 | 50 | 25 | none | <0.03 | 100 | 0.0 | 0 | 61.2 |
| C7E | 3.0 | 31.0 | 50 | 25 | none | <0.03 | 100 | 0.0 | 0 | 61.2 |
| C8 | 2.5 | 27.3 | 50 | 50 | A | <0.03 | 100 | 2.0 | 75 | 60.4 |
| C9 | 2.5 | 27.3 | 50 | 50 | B | <0.03 | 100 | 2.0 | 75 | 60.4 |
| C10 | 2.5 | 27.3 | 50 | 30 | C | <0.03 | 100 | 2.0 | 75 | 61.2 |
| C11 | 2.5 | 27.3 | 50 | 30 | D | <0.03 | 100 | 1.9 | 76 | 61.2 |
| 1 | 2.5 | 27.3 | 50 | 30 | D | 4.0 | 0 | 1.9 | 76 | 61.2 |
| 2 | 2.5 | 27.3 | 50 | 50 | E | 0.2 | 100 | 3.5 | 100 | 60.4 |
| 3 | 2.5 | 27.3 | 50 | 50 | E | 4.0 | 4 | 3.5 | 75 | 60.4 |
| 4 | 2.5 | 27.3 | 50 | 30 | F | 4.0 | 75 | 2.0 | 75 | 61.2 |
| 5 | 2.5 | 27.3 | 50 | 30 | G | 0.3 | 75 | 1.4 | 75 | 61.2 |
| 6 | 3.5 | 32.0 | 40 | 15 | G | 0.3 | 100 | 1.4 | 100 | 61.2 |
| 7 | 2.5 | 27.3 | 50 | 30 | H | 0.5 | 75 | 2.0 | 75 | 61.2 |
| 8 | 2.5 | 22.0 | 100 | 30 | I | 4.0 | 65 | 3.0 | 65 | 61.2 |
| 9 | 2.5 | 27.3 | 50 | 30 | I | 2.7 | 75 | 2.0 | 75 | 61.2 |
| 10 | 2.5 | 27.3 | 50 | 30 | J | 2.7 | 17 | 2.0 | 75 | 61.2 |
| 11 | 2.5 | 27.3 | 50 | 30 | K | 4.0 | 75 | 3.0 | 75 | 61.2 |
| 12 | 2.5 | 27.3 | 50 | 30 | none | 1.1 | 0 | 0.0 | 0 | 61.2 |
| 13 | 2.5 | 27.3 | 50 | 30 | none | 2.1 | 0 | 0.0 | 0 | 61.2 |
| 14 | 2.5 | 27.3 | 50 | 30 | none | 4.0 | 0 | 0.0 | 0 | 61.2 |
| 15 | 2.5 | 27.3 | 50 | 30 | none | 1.1 | 100 | 0.0 | 0 | 61.2 |
| 16 | 2.5 | 27.3 | 50 | 30 | none | 2.1 | 100 | 0.0 | 0 | 61.2 |
| 17 | 2.5 | 27.3 | 50 | 30 | none | 3.3 | 0 | 0.0 | 0 | 61.2 |
| 18 | 2.5 | 27.3 | 50 | 30 | none | 4.3 | 0 | 0.0 | 0 | 61.2 |
| 19 | 2.5 | 27.3 | 50 | 30 | L | 2.0 | 0 | 2.0 | 75 | 61.2 |
| 20 | 3.0 | 28.0 | 50 | 25 | none | 2.0 | 0 | 0.0 | 0 | 61.2 |
| 21 | 3.0 | 28.0 | 50 | 25 | none | 4.0 | 0 | 0.0 | 0 | 61.2 |
| 22 | 3.0 | 28.0 | 50 | 25 | none | 1.0 | 75 | 0.0 | 0 | 61.2 |
| 23 | 3.0 | 28.0 | 50 | 25 | none | 2.0 | 75 | 0.0 | 0 | 61.2 |
| 24 | 3.0 | 28.0 | 50 | 25 | none | 3.0 | 75 | 0.0 | 0 | 61.2 |
| 25 | 3.0 | 28.0 | 50 | 25 | none | 4.0 | 75 | 0.0 | 0 | 61.2 |
| 26 | 3.0 | 28.0 | 50 | 25 | none | 5.0 | 75 | 0.0 | 0 | 61.2 |

Key to table 2:
Column 1: Ex.: example number, C denotes comparative example;
Column 2: MS %: fraction of protective colloid, based on total monomer, in % by weight;
Column 3: Eth %: fraction of total ethylene, based on total monomer, in % by weight;
Column 4: Eth-IC %: fraction of ethylene in the initial charge, based on total ethylene, in % by weight;
Column 5: VAC-IC %: fraction of vinyl acetate in the initial charge, based on total vinyl acetate, in % by weight;
Column 6: Code for emulsifier specimen from table 1;
Column 7: Alkyl alcohol %: fraction of alkyl alcohol in % by weight, based on total monomer;
Column 8: Alkyl alcohol % in. ch.: fraction of alkyl alcohol in the initial charge in % by weight, based on total amount of alkyl alcohol;
Column 9: ME %: fraction of total emulsifier, based on total monomer, in % by weight;
Column 10: ME-IC %: fraction of emulsifier in the initial charge, based on total emulsifier, in % by weight;
Column 11: SC-F %: solids content according to formula in % by weight, based on dispersion.

TABLE 3
Data for the polymer dispersions

| | 2 | 3 | 4 | | | | |
|---|---|---|---|---|---|---|---|
| | SC- | Bf20- | Bf20 | | 6 | 7 | 8 |
| 1 | Ex | Ex | (60%) | 5 | Grit | K | [η] |
| Ex. | % | mPas | mPas | ×3, 50 nm | ppm | value | dl/g |
| C3 | 59.3 | 6.850 | 9.721 | 3.971 | 295 | 92 | 1.67 |
| C4 | 59.0 | 979 | 1.614 | 1.864 | 422 | 117 | 2.61 |
| C5 | 58.3 | 324 | 758 | 2.164 | 733 | 113 | 2.45 |
| C6 | 58.2 | 5.350 | 13.159 | 3.183 | 77 | 91 | 1.64 |
| C7A | 60.6 | 3.240 | 2.523 | 1.736 | 120 | n.d. | — |
| C7B | 60.0 | 4.850 | 2.179 | 2.135 | 286 | n.d. | — |
| C7C | 59.9 | 4.680 | 3.645 | 2.533 | 159 | n.d. | — |
| C7D | 59.1 | 6.900 | 5.649 | 2.739 | 134 | n.d. | — |
| C7E | 60.8 | 17.600 | 11.798 | 3.208 | 146 | n.d. | — |
| C8 | 58.6 | 1.750 | 3.524 | 883 | 200 | 116 | 2.57 |
| C9 | 58.9 | 3.860 | 6.690 | 588 | 191 | 113 | 2.45 |
| C10 | 57.7 | 4.490 | 14.180 | 607 | 46 | 110 | 2.33 |
| C11 | 60.7 | 2.130 | 1.501 | 637 | 163 | 99 | 1.92 |
| 1 | 59.2 | 1.696 | 2.530 | 689 | 102 | 110 | 2.33 |
| 2 | 58.3 | 504 | 1.179 | 945 | 442 | 94 | 1.74 |
| 3 | 58.8 | 703 | 1.281 | 1105 | 254 | 96 | 1.81 |
| 4 | 62.0 | 10.750 | 3.955 | 1.146 | 124 | 76 | 1.17 |
| 5 | 61.3 | 2.410 | 1.258 | 2.109 | 519 | 112 | 2.41 |
| 6 | 59.3 | 3.810 | 5.407 | 697 | 769 | 101 | 1.99 |
| 7 | 61.1 | 4.720 | 2.723 | 993 | 718 | 115 | 2.53 |
| 8 | 61.9 | 15.300 | 5.917 | 4.566 | 24 | 66 | 0.90 |
| 9 | 61.1 | 1.300 | 750 | 2.494 | 48 | 85 | 1.44 |
| 10 | 61.4 | 36.400 | 18.076 | 1.554 | 834 | 112 | 2.41 |
| 11 | 60.8 | 790 | 530 | 3.531 | 98 | 69 | 0.98 |
| 12 | n.d. | | | | | | |
| 13 | 57.2 | 326 | 1.322 | 1.888 | 69 | 107 | 2.21 |
| 14 | 58.9 | 1.230 | 2.132 | 2.036 | 148 | 114 | 2.49 |
| 15 | 59.4 | 1.000 | 1.350 | 1.935 | 187 | 106 | 2.17 |
| 16 | 57.2 | 326 | 1.322 | 1.888 | 69 | 107 | 2.21 |
| 17 | 59.6 | 2.428 | 2.965 | 1.805 | 187 | 109 | 2.29 |
| 18 | 58.9 | 1.230 | 2.132 | 2.036 | 148 | 114 | 2.49 |
| 19 | 61.2 | 5.345 | 2.933 | 912 | 76 | 111 | 2.37 |
| 20 | 60.0 | 2.620 | 2.620 | 1.890 | 92 | 106 | 2.17 |
| 21 | 59.1 | 1.830 | 2.870 | 2.836 | 187 | 97 | 1.84 |
| 22 | 59.7 | 1.660 | 1.929 | 1.925 | 475 | 97 | 1.84 |
| 23 | 60.2 | 2.680 | 2.425 | 1.857 | 213 | 107 | 2.21 |
| 24 | 60.2 | 2.700 | 2.443 | 1.599 | 240 | 116 | 2.57 |
| 25 | 60.9 | 4.400 | 2.806 | 1.368 | 432 | 117 | 2.61 |
| 26 | 59.6 | 4.800 | 5.863 | 1.255 | 452 | 99 | 1.92 |

Key to table 3:
Column 1: Ex.: example number, C denotes comparative example;
Column 2: SC-Ex %: experimental solids content in % by weight based on dispersion;
Column 3: Bf20-Ex: experimental Brookfield viscosity in mPas;
Column 4: Bf20 (60%): viscosity in mPas calculated for a solids content of 60% from columns 1 and 2;
Column 5: ×3, 50: central value of the volume distribution function of the particle size in nm;
Column 6: grit: sieve residue greater than 40 μm, in ppm;
Column 7: K value;
Column 8: intrinsic viscosity, determined from the K value, in dl/g;
n.d.: standards for “not determined”.

TABLE 4
Adhesives properties of the polymer dispersions

| | 2 | 3 | | 5 | 6 | 7 |
|---|---|---|---|---|---|---|
| 1 | TS | Cohesion | 4 | Adh PS | Adh PET1 | Adh PET2 |
| Ex. | sec | N/mm² | CA | N/cm | N/cm | N/cm |
| Cl | 1.4 | 0.5 | 15 | 10.8 | 2.5 | 0.5 |
| C2 | 2.4 | <0.1 | 10 | 4.8 | 7.6 | 3.0 |
| C3 | 5.0 | 0.9 | 23 | 3.0 | 2.1 | 2.9 |
| C4 | 1.2 | 1.0 | 18 | 3.1 | 3.3 | 1.2 |
| C5 | 1.4 | 1.3 | 17 | 3.5 | 3.4 | 1.3 |
| C6 | 2.4 | 1.0 | 21 | 3.6 | 3.2 | 2.6 |
| C7A | 1.6 | 1.2 | 16 | 3.0 | 3.5 | 0.6 |
| C7B | 2.6 | 1.0 | 18 | 3.5 | 3.0 | 1.4 |
| C7C | 2.0 | 1.0 | 20 | 3.6 | 3.2 | 2.7 |
| C7D | 2.0 | 1.0 | 20 | 3.7 | 3.5 | 3.0 |
| C7E | 1.4 | 1.0 | 21 | 3.3 | 3.7 | 2.9 |
| C8 | 1.6 | 0.6 | — | 2.9 | 2.6 | 1.5 |
| C9 | 1.4 | 0.6 | — | 4.5 | 1.7 | — |
| C10 | 1.4 | 0.7 | — | 2.7 | 2.6 | 2.0 |
| C11 | 1.8 | 0.6 | — | 3.0 | 4.9 | 2.1 |
| 1 | 1.4 | 0.5 | 16 | 4.1 | 4.8 | 2.1 |
| 2 | 2.4 | 0.4 | 16 | 4.4 | 4.0 | 2.1 |
| 3 | 2.2 | 0.4 | 15 | 5.3 | 4.3 | 2.3 |
| 4 | 2.8 | 0.2 | 17 | 4.9 | 4.7 | 2.3 |
| 5 | 2.4 | 0.5 | 16 | 4.6 | 4.1 | 2.1 |
| 6 | 2.4 | 0.4 | 15 | 5.6 | 4.1 | 2.1 |
| 7 | 2.4 | 0.6 | 16 | 5.0 | 4.1 | 2.3 |
| 8 | 3.0 | 0.3 | 17 | 4.1 | 4.5 | 2.4 |
| 9 | 1.6 | 0.3 | 14 | 4.1 | 5.5 | 2.6 |
| 10 | 2.6 | 0.5 | 16 | 4.4 | 5.3 | 2.3 |
| 11 | 3.0 | 0.2 | 17 | 4.2 | 8.7 | 2.6 |
| 12 | 1.5 | 0.9 | 16 | 3.8 | 3.4 | 1.4 |
| 13 | 1.2 | 0.8 | 15 | 4.3 | 3.9 | 1.4 |
| 14 | 1.6 | 0.7 | 17 | 4.7 | 4.4 | 1.8 |
| 15 | 1.5 | 0.9 | 16 | 4.1 | 4.1 | 1.6 |
| 16 | 1.2 | 0.8 | 15 | 4.5 | 4.2 | 1.8 |
| 17 | 1.7 | 0.8 | 17 | 4.4 | 4.1 | 1.7 |
| 18 | 1.6 | 0.6 | 18 | 5.0 | 4.8 | 2.1 |
| 19 | 1.3 | 0.5 | 14 | 6.2 | 4.2 | 2.1 |
| 20 | 1.8 | 0.8 | 16 | 4.3 | 4.5 | 2.9 |
| 21 | 2.4 | 0.8 | 18 | 5.2 | 4.6 | 3.2 |
| 22 | 1.6 | 0.9 | 15 | 4.2 | 4.1 | 1.6 |
| 23 | 1.2 | 0.8 | 17 | 5.0 | 4.7 | 2.2 |
| 24 | 1.4 | 0.7 | 16 | 5.4 | 6.3 | 3.2 |
| 25 | 1.2 | 0.6 | 17 | 6.5 | 11.8 | 3.2 |
| 26 | 1.4 | 0.5 | 18 | 7.8 | 8.4 | 3.2 |

Key to table 4:
Column 1: Ex.: example number, C denotes comparative example;
Column 2: TS: setting rate, measured as TS in sec;
Column 3: Cohesion: cohesion determined as thermal stability in N/mm²;
Column 4: CA: cumulative adhesion;
Column 5: Adh PS: adhesion/peel strength in N/cm to Sidaplax ® Polyflex 90 polystyrene:
Column 6: Adh PET1: adhesion/peel strength in N/cm to Hostaphan ® RN125 polyethylene terephthalate at a peel rate of 10 mm/min (slow peel: PET1);
Column 7: Adh PET2: adhesion/peel strength in N/cm to Hostaphan ® RN125 polyethylene terephthalate at a peel rate of 900 mm/min (fast peel: PET2).

1. A process for preparing vinyl acetate-ethylene copolymers by means of radically initiated emulsion polymerization of vinyl acetate, ethylene, and optionally one or more further comonomers in the presence of at least one protective colloid and optionally at least one emulsifier, wherein
the vinyl acetate-ethylene copolymers contain 18% to 45% by weight of ethylene units, based on the total weight of the vinyl acetate-ethylene copolymers, and
at least 70% by weight of ethylene units, based on the total weight of the ethylene units and of the further comonomer units of the vinyl acetate-ethylene copolymers,
and
the radically initiated emulsion polymerization is carried out in the presence of
A) 0.5% to 20% by weight, based on the total weight of the entirety of monomers used, of one or more solvents selected from the group consisting of linear or cyclic glycol ethers and alkyl alcohols, or
B) 0.1% to 20% by weight, based on the total weight of the entirety of monomers used, of one or more solvents selected from the group consisting of linear or cyclic glycol ethers and alkyl alcohols and
0.5% to 4% by weight, based on the total weight of the entirety of monomers used, of one or more anionic sulfosuccinic esters of the general formula
R¹—O—CO—CH₂—CH(SO₃M)-CO—O—R¹ (I)
in which
M is a cation,
R¹ is a linear or branched alkyl radical having 4 to 17 C atoms, an alkylene oxide group —(R²—O)ₙ—X, or a cation M, where
R² is a linear or branched alkylene unit having 2 to 5 C atoms,
n is an integral value from 2 to 20, and
X is a linear or branched alkyl radical having 4 to 17 C atoms,
where not more than one radical R¹ in the general formula (I) is a cation M.

2. The process for preparing vinyl acetate-ethylene copolymers of claim 1, wherein anionic sulfosuccinic esters of the general formula (I) are selected from the group consisting of dioctyl sulfosuccinates, diethylhexyl sulfosuccinates, didecyl sulfosuccinates, diisotridecyl sulfosuccinates, monoesters of sulfosuccinate esters of the general formula (I), in which R¹ is —(R²—O)ₙ—X and R² is an alkylene unit having two C atoms, X is a linear or branched alkyl radical having 10 to 12 C atoms, and n is an integral value from 3 to 6, and M is a cation, and diesters of the sulfosuccinic esters of the general formula (I), in which R¹ is —(R²—O)ₙ—X and R² is an alkylene unit having 2 C atoms, X is a linear or branched alkyl radical having 6 to 14 C atoms, and n is an integral value from 2 to 10, and M is a cation.

3. The process for preparing vinyl acetate-ethylene copolymers of claim 1, wherein all of the radicals R¹ in the anionic sulfosuccinic esters of the general formula (I) are linear or branched alkyl radicals having 4 to 17 C atoms or are alkylene oxide groups —(R²—O)ₙ—X.

4. The process for preparing vinyl acetate-ethylene copolymers of claim 1, wherein in process B) the anionic sulfosuccinic esters of the general formula (I) are present in an amount of 11.1% to 80.0% by weight, based on the total weight of the protective colloids and anionic sulfosuccinic esters of the general formula (I), during the emulsion polymerization.

5. The process for preparing vinyl acetate-ethylene copolymers of claim 1, wherein in process A) no emulsifier is used.

6. The process for preparing vinyl acetate-ethylene copolymers of claim 1, wherein one or more solvents are used that are selected from the group consisting of alkyl alcohols, diols, or triols, and linear or cyclic glycol ethers.

7. The process for preparing vinyl acetate-ethylene copolymers of claim 1, wherein the protective colloids are present in an amount of in total 1% to 7% by weight, based on the total weight of the monomers, during the emulsion polymerization.

8. The process for preparing vinyl acetate-ethylene copolymers of claim 1, wherein the vinyl acetate is introduced at 10% to 70% by weight, based on the total weight of the entirety of vinyl acetate used, before the emulsion polymerization is initiated.

9. The process for preparing vinyl acetate-ethylene copolymers of claim 1, wherein the ethylene is introduced at 40% to 100% by weight, based on the total weight of the entirety of ethylene used, before the emulsion polymerization is initiated.

10. The process for preparing vinyl acetate-ethylene copolymers of claim 1, wherein the emulsifiers are introduced at at least 25% by weight, based on the total weight of the entirety of emulsifiers used, before the emulsion polymerization is initiated.

11. The process for preparing vinyl acetate-ethylene copolymers of claim 1, wherein the vinyl acetate-ethylene copolymers contain no units of further comonomers and/or no units of auxiliary monomers.

12. Vinyl acetate-ethylene copolymers in the form of aqueous dispersions having a volatile organic substances content of <2000 ppm, based on the weight of the aqueous dispersions, obtained by means of radically initiated emulsion polymerization of vinyl acetate, ethylene, and optionally one or more further comonomers in the presence of at least one protective colloid and at least one emulsifier, and
optionally, distillative removal of volatile organic substances, wherein
the vinyl acetate-ethylene copolymers contain 18% to 45% by weight of ethylene units, based on the total weight of the vinyl acetate-ethylene copolymers, and
at least 70% by weight of ethylene units, based on the total weight of the ethylene units and of the further comonomer units of the vinyl acetate-ethylene copolymers,
and
the radically initiated emulsion polymerization is carried out in the presence of 0.1% to 20% by weight, based on the total weight of the entirety of monomers used, of one or more solvents selected from the group consisting of linear or cyclic glycol ethers and alkyl alcohols and
0.5% to 4% by weight, based on the total weight of the entirety of monomers used, of one or more anionic sulfosuccinic esters of the general formula
R¹—O—CO—CH₂—CH(SO₃M)-CO—O—R¹ (I)
in which
M is a cation,
R¹ is a linear or branched alkyl radical having 4 to 17 C atoms, an alkylene oxide group —(R²—O)ₙ—X, or a cation M, where
R² is a linear or branched alkylene unit having 2 to 5 C atoms,
n is an integral value from 2 to 20, and
X is a linear or branched alkyl radical having 4 to 17 C atoms,
where not more than one radical R¹ in the general formula (I) is a cation M.

13. The vinyl acetate-ethylene copolymers in the form of aqueous dispersions of claim 12, wherein the volatile organic substances under atmospheric pressure have a boiling point of less than 250° C.

14. The Vinyl acetate-ethylene copolymers in the form of water-redispersible polymer powders obtained by drying the vinyl acetate-ethylene copolymers in the form of aqueous dispersions according to claim 12.

15. The use of the vinyl acetate-ethylene copolymers of claim 12 as or in adhesives for the bonding of cellulosic materials.

16. The use of the vinyl acetate-ethylene copolymers of claim 12 as binders and/or coating materials for fibrous substances or structures.
